(19) United States
(12) Patent Application Publication
(10) Pub. No.: US 2001/0051862 A1
(43) Pub. Date: Dec. 13, 2001

(54) Simulator, simulation method, and a computer product

(75) Inventors: Koji Ishibashi, Kawasaki (JP); Naohiro Tamura, Kawasaki (JP); Eiichi Takahashi, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 09/804,092

(22) Filed: Mar. 12, 2001

(30) Foreign Application Priority Data
Jun. 9, 2000 (JP) 2000-173384

(51) Int. Cl. G06F 17/50

(52) U.S. Cl. 703/14

(57) ABSTRACT

The simulator is provided with a control section that gathers the parameters of a plurality of parts in a computer network and that thereby predicts a future state of the computer network over a prescribed period of time. Further, a scenario creation/management creates a model corresponding to the computer network. Finally, simulation engine executes the simulation on the basis of the created model.

### FIELD OF THE INVENTION

The present invention relates to a simulator, simulation method, and computer-readable recording medium having recorded therein a simulation program, which for example can perform future prediction of the service level of a network system without necessitating a high level of special knowledge.

### BACKGROUND OF THE INVENTION

In recent years, due to a wide spread of the Internet communications, even an ordinary user has been becoming more and more interested in the network system. Especially, the response time length in the Web browser has gotten even on an Internet or network beginner's nerves. Further, for an enterpriser who has provided the Web contents, such response time length is needless to say a matter of great concern.

On the other hand, the spread of the network system within, or in connection with, the enterprises has gotten striking. Training of the network technicians has therefore been unable to catch up with their demand, with the result that the enterprises have been at all times in a state of being short of their network technicians.

The network technicians are demanded to have a technique of performing a future prediction of the network with a high level of special knowledge on the network, simulation, waiting queue, statistics, etc. Also, in the enterprises, in many cases, the basic part of the network is maintained and managed by the out-sousing whereas other part thereof is maintained and managed by managers who don't have their knowledge on the network very much.

Under the above-described circumstances, there has been an earnest desire for appearance of the means or method that enables performing future prediction of the network without necessitating a high level of knowledge on the network, simulation, waiting queue, statistics, etc. and without troubling a professional such as a network technician or consultant.

As a method for solving the problems that will arise in reality, there have hitherto been used in a wide variety of fields a simulation of creating a model, which represents the nature of, or the relationship between, the pieces of event occurring in reality, using a computer and of causing a change of each parameter with respect to that model. Here, the computer simulation is roughly classified into two types, one being a continuous simulation and the other being a discrete simulation.

In the former continuous simulation, the behavior of change in the state of event is grasped as a quantity that changes continuously, whereby the event is modeled. On the other hand, in the latter discrete simulation, the behavior of change in the state of event is grasped as occurring from and about the point in time at which an important piece of change has taken place, whereby the event is modeled.

FIG. 41 is a view illustrating the above-described discrete type simulation. In this figure, there is illustrated a modeled object system. The model that has been illustrated in this figure represents a piece of event wherein waiting queues 4₁ to 4₆ occur with respect to a plurality of resources (the circles in the same figure). Namely, this model is a multi-stage waiting queue model. In each of the waiting queues 4₁ to 4₆, an entity takes part in the queue at an entity arrival rate λ₁ to λ₆. The entity arrival rate λ₁ to λ₆ is the number of entity arrivals per unit length of time.

Also, in the resources corresponding to the waiting queues 4₁ to 4₆, pieces of processing with respect to their corresponding entities are executed at their resource service rates μ₁ to μ₆. The resource service rate μ₁ to μ₆ is the number of entity processings per unit length of time. These entity arrival rates λ₁ to λ₆ and resource service rates μ₁ to μ₆ are the parameters (variable factors) in the discrete simulation.

In the discrete simulation, first, a scenario of how what parameter should be changed is prepared. Then, according to the thus-prepared scenario, simulation is executed. Also, after executing the simulation, according to the result of the simulation, discovery is made of a bottleneck (shortage of the resource, etc.). Thereby, measures are taken for solving this bottleneck.

FIG. 42 is a flowchart illustrating a conventional operation sequence of simulator at the time of future prediction. Namely, this figure is a flowchart illustrating the operation sequence of a conventional simulator wherein a discrete simulation (hereinafter referred to simply as “a simulation”) is applied to a network such as that for Internet communications, and which performs future prediction of the service level (e.g. the response time) of that network.

In step SA1 illustrated in this figure, the user creates a model corresponding to the network that is an object to be simulated, and stores this model into a storage device of the simulator. In this case, the user is needed to have special knowledge on the creation of topology and the method of gathering the performance data of the network machines. In step SA2, the user sorts a desired one from among the traffic parameters (the packets number, packet size, transaction, etc.) that are used in the simulation. In this case, the user is needed to have special knowledge on the kinds of packets, kinds of transactions, protocol, and network architecture. In step SA3, the user selects means for gathering the traffic parameters sorted in the step SA2, from among a plurality of traffic parameter gathering unit. In this case, the user is needed to have special knowledge on the demerits, merits, use method, etc. of an SNMP (Simple Network Management Protocol), RMON (Remote Network Monitoring), Sniffer (an analyzer for analysis and monitoring of network bottleneck), etc.

In step SA4, a control section 210 gathers traffic parameters from the actual network over a prescribed length of time by the traffic parameter gathering unit that has been selected in the step SA3. In this case, the user is needed to have a know-how on the gathering place, gathering time length, gathering point in time, conversion of the gathered data, use method of a gathering machine, etc. concerning the traffic parameters. These traffic parameters are kept in storage as history data. In step SA5, the user performs projection calculation of the history data (the traffic parameters) with use of a statistical method. The wording “projection calculation” referred to here means calculation for future prediction of the traffic parameters performed at a future point in time as counted onward from the present point in time by a projection length of time. Accordingly, the user is needed to have special knowledge on various kinds of methods for projection calculation, and on statistics and mathematics.

In step SA6, through the user's operation, the projection-calculated traffic parameters are loaded into the simulator. In step SA7, the simulator executes simulation with use of the model and traffic parameters stored in the storage device. In the steps SA6 and SA7, the user is needed to have special knowledge on the operation method of the simulator and special knowledge for enhancing the simulation precision (e.g. Warm up run, replication) The simulated result of the simulation is one for making a determination of whether the relevant model (network) satisfies a prescribed service level. In step SA8, the user determines on the result of the simulation. In this case, the user is needed to have special knowledge on the statistics for making analysis of the result of the simulation.

By the way, as described above, conventionally, all steps in the series of processings from the step SA1 to SA6 illustrated in FIG. 42 intended to perform future prediction must be performed by the user himself. Here, a professional user who has a good deal of knowledge on the simulation and model architecture would be able to easily execute such series of processings for performing future prediction.

In contrast to this, for an ordinary user who has no such knowledge, it is difficult for him to easily perform future prediction. The reason for this is that the user is compelled to perform an operation requiring the use of a high level of special knowledge. The operation includes the creation of the model, gathering of the traffic parameters (hereinafter referred to simply as “the parameters”), projection calculation, loading of the projection calculation result into the simulator, and determination on the simulated result.

Also, conventionally, it is certainly possible to determine on whether the result of simulation satisfies a prescribed service level. However, in case the result of simulation doesn't satisfy the service level, the user has the difficulty of analyzing what part of the network is being a latent bottleneck unless he is an expert. Accordingly, in the conventional future prediction technique, there was the problem that the fundamental countermeasure on network of discovering such a bottleneck and eliminating this bottleneck could not quickly be taken.

Also, conventionally, in case having changed the parameters on network, verifying how the service level is improved cannot easily be performed, either. Namely, it is difficult to accurately perform future prediction of the service level. Further, conventionally, future prediction can be performed over only a short time period of several hours or so and quantitative simple performance of the future prediction over a relatively long period of time (several months) is impossible.

### SUMMARY OF THE INVENTION

It is an object of this invention to provide a simulator, simulation method, and computer-readable recording medium having recorded therein a simulation program, which enable easily performing future prediction of the network status (service level) and in addition enable analyzing the bottleneck of the network without burdening the user with a high level of knowledge on simulation and burdening a load upon the user.

The simulator according to one aspect of this invention comprises parameter a gathering unit that gathers parameters from a plurality of portions in a network, a future prediction unit that according to the gathered parameters predicts a future state in the network over a prescribed length of time, model creation unit that creates a model corresponding to the network, a parameter application unit that applies the gathered parameters to the model, and a simulation unit that executes simulation according to the model.

According to the invention, a series of processes including gathering of the parameters, future prediction, model creation, and simulation are automated. This enables easily performing future prediction of the network status (service level) without burdening a high level of knowledge or a load upon the user.

Other objects and features of this invention will become apparent from the following description with reference to the accompanying drawings.

### BRIEF DESCRIPTION OF THE DRAWINGS

FIG. 1 is a block diagram illustrating the construction of an embodiment of the present invention;

FIG. 2 is a diagram illustrating the construction of the computer network 100 illustrated in FIG. 1;

FIG. 3 is a view illustrating the structure of the simulation data 540 illustrated in FIG. 1;

FIG. 4 is a view illustrating various parameters that are used in the embodiment;

FIG. 5 is a view illustrating an example of the topology data 410 illustrated in FIG. 1;

FIG. 6 is a view illustrating an example of the object-to-be-managed device performance data 420 illustrated in FIG. 1;

FIG. 7 is a view illustrating examples of the traffic history data 430 and traffic for-the-future projection value data 440 illustrated in FIG. 1;

FIG. 8 is a view illustrating examples of the transaction history data 450 and transaction projection data 460 illustrated in FIG. 1;

FIG. 9 is a flowchart illustrating the operation of the operation/management server 200 illustrated in FIG. 1;

FIG. 10 is a flowchart illustrating an object-to-be-managed data gathering execution task execution process illustrated in FIG. 9;

FIG. 11 is a flowchart illustrating the between-segment topology search task execution process illustrated in FIG. 9;

FIG. 12 is a flowchart illustrating the link/router performance measurement task execution process illustrated in FIG. 9;

FIG. 13 is a flowchart illustrating the HTTP server performance measurement task execution process illustrated in FIG. 9;

FIG. 14 is a flowchart illustrating the noise traffic gathering task execution process illustrated in FIG. 9;

FIG. 15 is a flowchart illustrating the noise transaction gathering task execution process illustrated in FIG. 9;

FIG. 16 is a flowchart illustrating the noise traffic for-the-future projection task execution process illustrated in FIG. 9;

FIG. 17 is a flowchart illustrating the noise transaction for-the-future projection task execution process illustrated in FIG. 9;

FIG. 18 is a flowchart illustrating the operation of the operation/management client 300 illustrated in FIG. 1;

FIG. 19 is a flowchart illustrating the model setting process illustrated in FIG. 18;

FIG. 20 is a view illustrating an image screen 700 in the model setting process illustrated in FIG. 18;

FIG. 21 is a view illustrating an image screen 710 in the model setting process illustrated in FIG. 18;

FIG. 22 is a view illustrating an image screen 720 in the model setting process illustrated in FIG. 18;

FIG. 23 is a view illustrating an image screen 730 in the model setting process illustrated in FIG. 18;

FIG. 24 is a flowchart illustrating the model creation process illustrated in FIG. 19;

FIG. 25 is a view illustrating an image screen 740 in the topology display process illustrated in FIG. 18;

FIG. 26 is a flowchart illustrating the future prediction setting process illustrated in FIG. 19;

FIG. 27 is a view illustrating an image screen 750 in the future prediction setting process illustrated in FIG. 18;

FIG. 28 is a view illustrating an image screen 760 in the future prediction setting process illustrated in FIG. 18;

FIG. 29 is a view illustrating an image screen 770 in the future prediction setting process illustrated in FIG. 18;

FIG. 30 is a flowchart illustrating the simulation execution process illustrated in FIG. 18;

FIG. 31 is a flowchart illustrating the result display process illustrated in FIG. 18;

FIG. 32 is a view illustrating an image screen 780 in the result display process illustrated in FIG. 18;

FIG. 33 is a view illustrating an image screen 790 in the result display process illustrated in FIG. 18;

FIG. 34 is a view illustrating an image screen 800 in the result display process illustrated in FIG. 18;

FIG. 35 is a view illustrating an image screen 810 in the result display process illustrated in FIG. 18;

FIG. 36 is a view illustrating an image screen 820 in the result display process illustrated in FIG. 18;

FIG. 37 is a view illustrating an image screen 830 in the result display process illustrated in FIG. 18;

FIG. 38 is a view illustrating an image screen 840 in the result display process illustrated in FIG. 18;

FIG. 39 is a view illustrating an image screen 850 in the result display process illustrated in FIG. 18;

FIG. 40 is a block diagram illustrating a modification of the embodiment;

FIG. 41 is a view illustrating a discrete type simulation; and

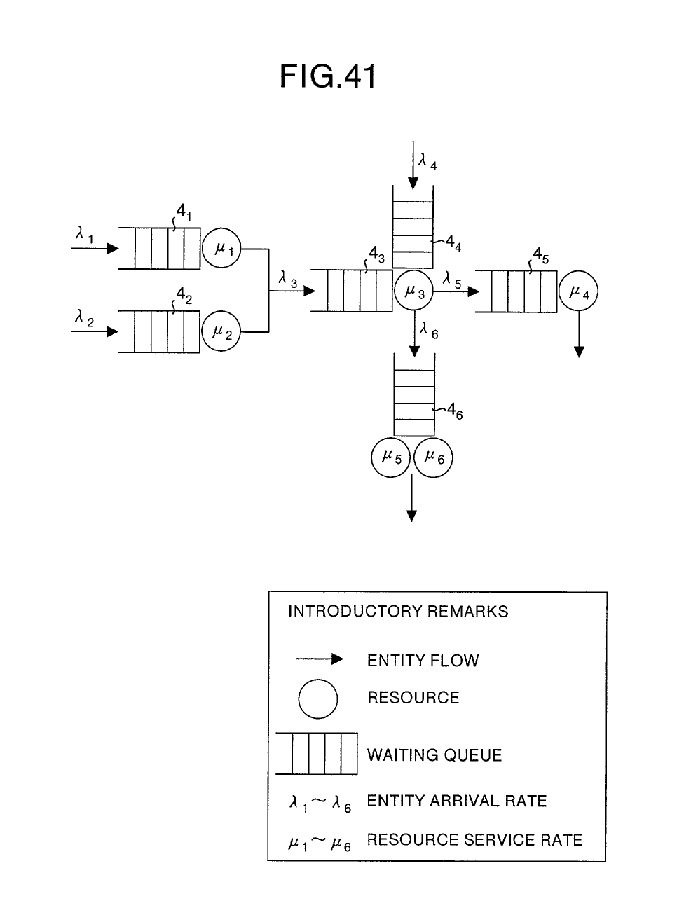

FIG. 42 is a flowchart illustrating a conventional operation sequence of simulator at the time of future prediction.

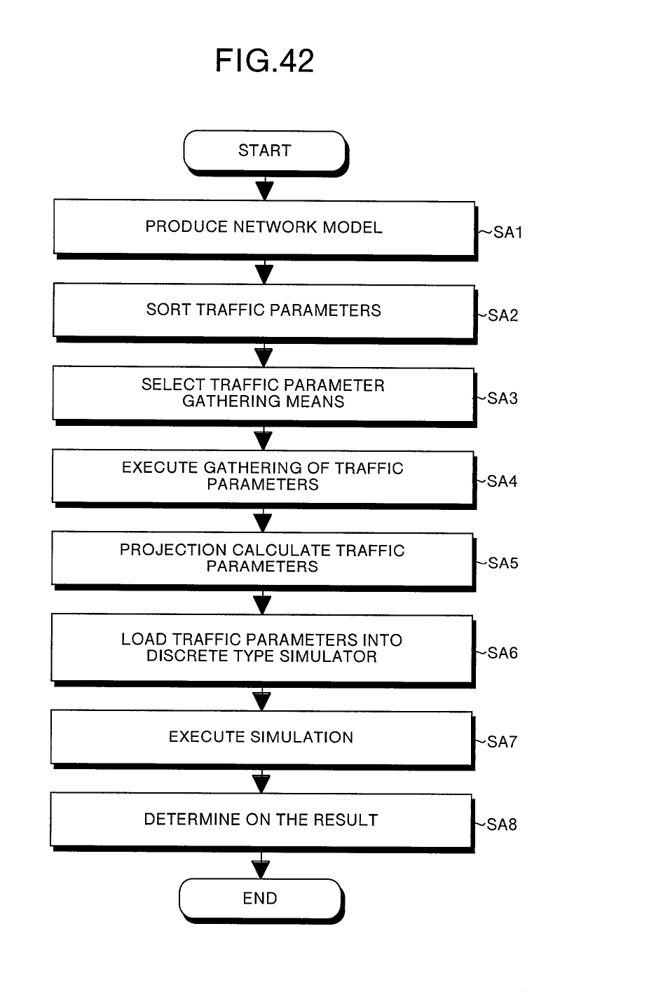

### DESCRIPTION OF THE PREFERRED EMBODIMENTS

Preferred embodiment of a simulator, simulation method, and computer-readable recording medium having recorded therein a simulation program according to the present invention will hereafter be explained in detail with reference to the drawings.

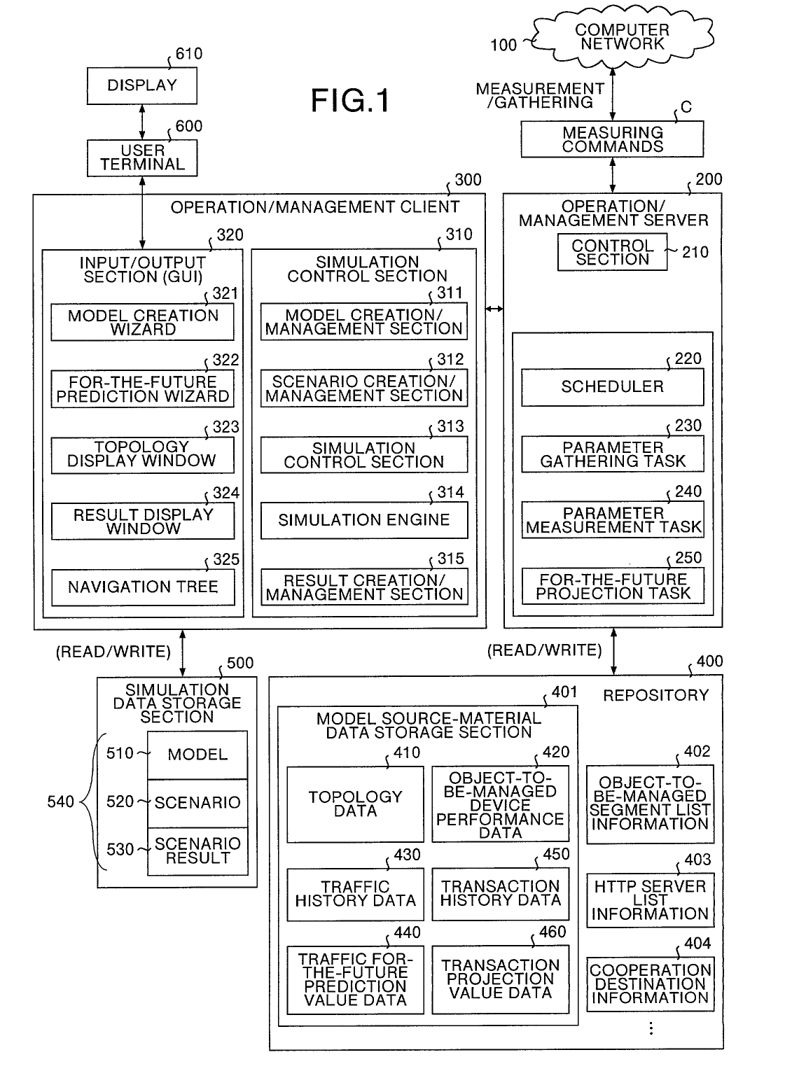

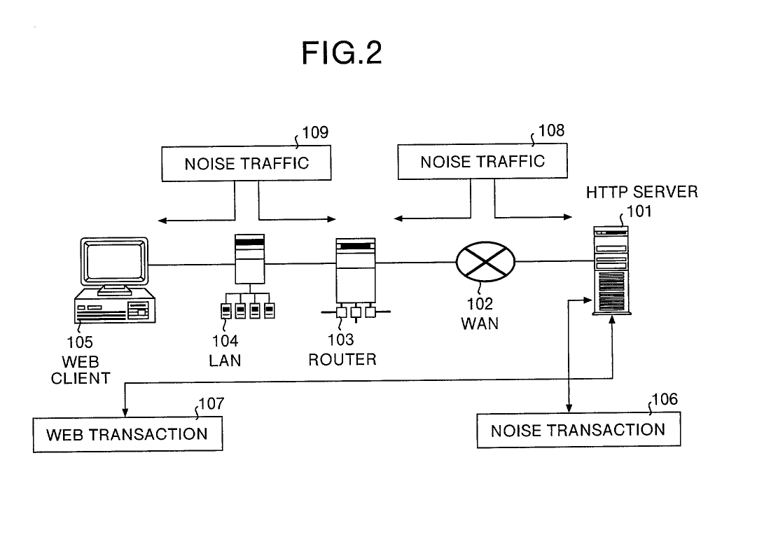

FIG. 1 is a block diagram illustrating the construction of an embodiment of the present invention. In this figure, a computer network 100 is an object with respect to that future prediction and design support are to be performed, and has a construction illustrated in FIG. 2. The wording “future prediction” that is used here means executing a simulation with use of a model corresponding to the network, with respect to which the parameters are variably set, thereby searching for the items of conditions under which the existing network now satisfying the performance standard will cease to satisfy it in the future. Also, the wording “design support” means making a definition of to what extent what parameters should be changed in order to make the model wherein the simulated result of the relevant network doesn't satisfy the performance standard a model wherein it satisfies the performance standard.

Also, the parameters that are handled in this embodiment include the following four kinds of parameters (1) to (4).

(1) Topology . . . the parameters regarding the forms of disposition and the routes of the network machines, such as linkages between or among them.

(2) Service rate . . . the parameters regarding the processing speeds, such as the performance of the network machines or performance of the computers.

(3) Qualitative arrival rate . . . the parameters representing the degree of crowdedness of the system as qualitative data, such as the amount of traffic of the network. As an example of the qualitative data there can be taken up the number of staff members, the number of machines, etc. that are going to be increased in future.

(4) Quantitative arrival rate . . . the parameters representing the degree of crowdedness of the system as quantitative data, such as the amount of traffic of the network. As an example of the quantitative data there can be taken up a log (history data).

In FIG. 2, a HTTP (Hyper-Text Transfer Protocol) server 101 is a server that according to the HTTP and according to a demand for transfer issued from a Web client 105 transfers an HTML (Hyper Makeup Language) file or an image file to the Web client 105. This HTTP server 101 is connected to a WAN (Wide Area Network) 102.

To the WAN 102 there is connected via a router 103 a LAN (Local Area Network) 104. The Web client 105 is connected to the LAN 104 and issues a demand for transfer to the HTTP server 101 via the LAN 104, router 103, and WAN 102, and receives an HTML file or image file from this HTTP server 101. Here, the length of time that is needed from the issuance of the demand for transfer by the Web client 105 until this Web client 105 receives an HTML file or image file (the length of time from the start to the end of one transaction) is a round-trip time period (the meaning of that is the same as the response time). Namely, that length of time is the parameter that is used to determine whether the computer network 100 satisfies its performance standard (service level).

A noise transaction 106 is a transaction that is processed between each of a non-specified number of Web clients (not illustrated) and the HTTP server 101. A Web transaction 107 is a transaction that is processed between the Web client 105 and the HTTP server 101. A noise traffic 108 is a traffic that is processed between the HTTP server 101 and the router 103. A noise traffic 109 is a traffic that flows between the Web client 105 and the router 103.

An operation/management server 200 illustrated in FIG. 1 is a server that operates and manages the computer network 100. In this operation/management server 200, a control section 210 controls the executions of various kinds of tasks regarding the simulation. The control section 210 executes a parameter-gathering task 230, parameter-measuring task 240, and for-the-future projection task 250 according to the task execution schedule preset by the user.

A scheduler 220 performs scheduling of the task execution. The parameter-gathering task 230 is a task for gathering parameters from the computer network 100. The parameter-measuring task 240 is a task for measuring the parameters in the computer network 100 according to measuring commands C. The for-the-future projection task 250 is a task for executing for-the-future projection as later described.

An operation/management client 300 is interposed between a user terminal 600 and the operation/management server 200. Through the use of a GUI (Graphical User Interface), a display 610 is connected to the user terminal 600. Thereby, the client 300 has the function of displaying on the display 610 various kinds of icons and windows that are necessary for the simulation, and the function of executing the simulation. The operation/management client 300 is constructed of a simulation control section 310 that controls the execution of the simulation and an input/output section 320.

In the simulation control section 310, a model creation/management section 311 creates and manages a model in accordance with that simulation is performed. A scenario creation/management section 312 creates and manages a scenario in accordance with that simulation is performed. A simulation control section 313 controls the execution of the simulation. A simulation engine 314 executes the simulation under the control of the simulation control section 313. A result creation/management 315 creates and manages the result of the simulation that is performed by the simulation engine 314.

In the input/output section 320, a model creation wizard 321 has the function of displaying a sequence for creating a model on the display 610. A future prediction wizard 322 has the function of displaying the sequence for performing future prediction on the display 610. A topology display window 323 is a window for displaying a graphic-object-to-be-simulated topology on the display 610.

A result display window 324 is a window for displaying the simulation result on the display 610. A navigation tree 325 is one for performing navigation of the operation sequence, etc. of the simulation. The user terminal 600 is a computer terminal for issuance of various kinds of commands or instructions with respect to the simulator or for causing display of various pieces of information on the display 610.

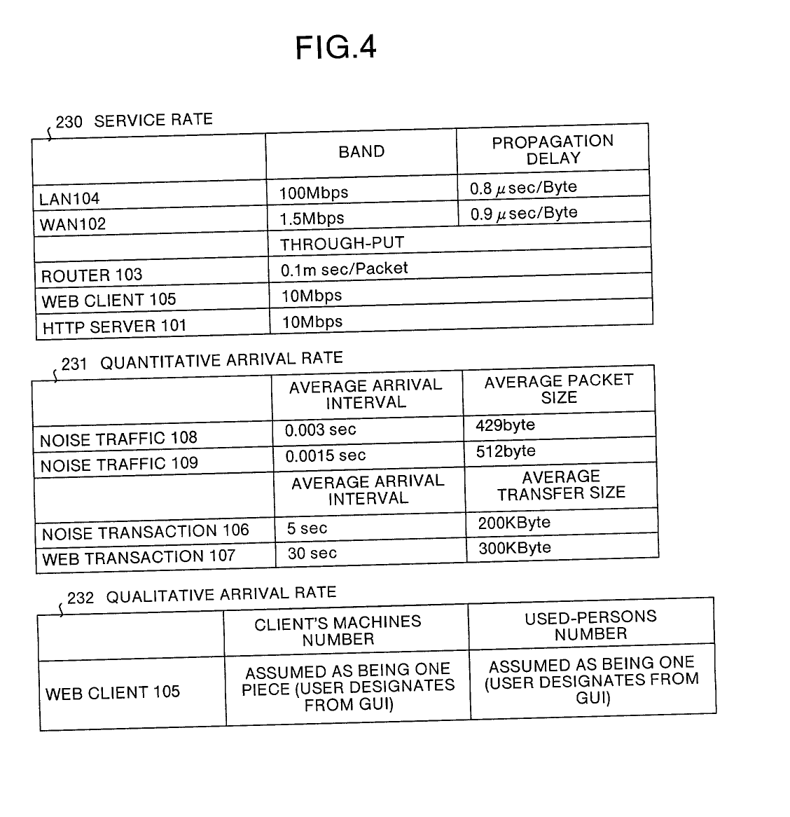

FIG. 4 is a view illustrating various parameters that are used in this embodiment. In this figure, of the above-described four parameters (topology, service rate, quantitative arrival rate, and qualitative arrival rate), respective examples of the three parameters (the service rate 230, quantitative arrival rate 231, and qualitative arrival rate 232) having relevance to the computer network 100 illustrated in FIG. 2 are illustrated.

In the service rate 230, the service rate of the LAN 104 (see FIG. 2) is “band” (=100 Mbps) and “propagation delay” (=0.8 μsec/Byte). The service rate of the WAN 102 is “band” (=1.5 Mbps) and “propagation delay” (=0.9 μsec/Byte). The service rate of the router 103 is “through-put” (=0.1 msec /packet). The service rate of the Web client 105 is “through-put” (=10 Mbps). The service rate of the HTTP server 101 is “through-put” (=10 Mbps).

In the quantitative arrival rate 231, the quantitative arrival rate of the noise traffic 108 is “average arrival interval” (=0.003 sec). The “average packet size” in this case is 429 byte. The quantitative arrival rate of the noise traffic 109 is “average arrival interval” (=0.0015 sec). The “average packet size” in this case is 512 byte.

The quantitative arrival rate of the noise transaction 106 is “average arrival interval” (=5 sec). The “average transfer size” in this case is 200 Kbyte. The quantitative arrival rate of the Web transaction 107 is “average arrival interval” (=30 sec). The “average transfer size” in this case is 300 Kbyte. In the qualitative arrival rate 232, the qualitative arrival rate of the Web client 105 is “client's machines number” (=assumed to be one piece of machine) and “utilized-persons number” (=assumed to be one person).

Turning back to FIG. 1, a repository 400 is for the purpose of storing various kinds of data (object-to-be-managed segment list information 402, model source-material data storage section 401, HTTP server list information 403, etc. . . . that will be later described) that are used in the operation/management server 200. In this repository 400, in the model source-material data storage section 401, there are written various kinds of data (model source-material data) necessary for simulation under the write control of the operation/management server 200. Also, from the model source-material data storage section 401, there are read various kinds of data under the read control of the operation/management server 200. Concretely, in the model source-material data storage section 401, there are stored topology data 410, object-to-be-managed device performance data 420, traffic history data 430, traffic for-the-future projection value data 440, transaction history data 450, and transaction projection value data 460.

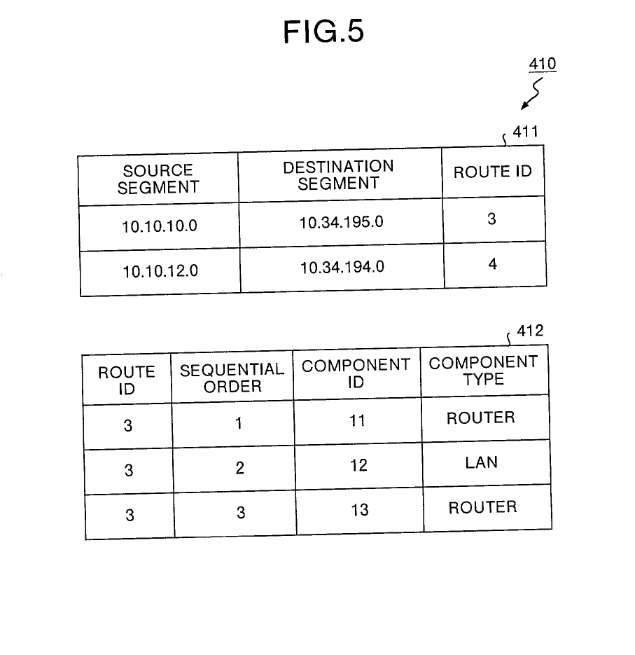

The topology data 410 is constructed of topology data 411 and topology data 412 as illustrated in FIG. 5, and is data that represents the topology (the connected or linked state of the network machines) of the computer network 100. The topology data 411 is constructed of “source segment” data, “destination segment” data, and “route ID” data. The topology data 412 is constructed of “route ID” data, “sequential order” data, “component ID” data, and “component kind” data. For example, the “component ID”=11 represents an identification number for identifying the router 103 illustrated in FIG. 2.

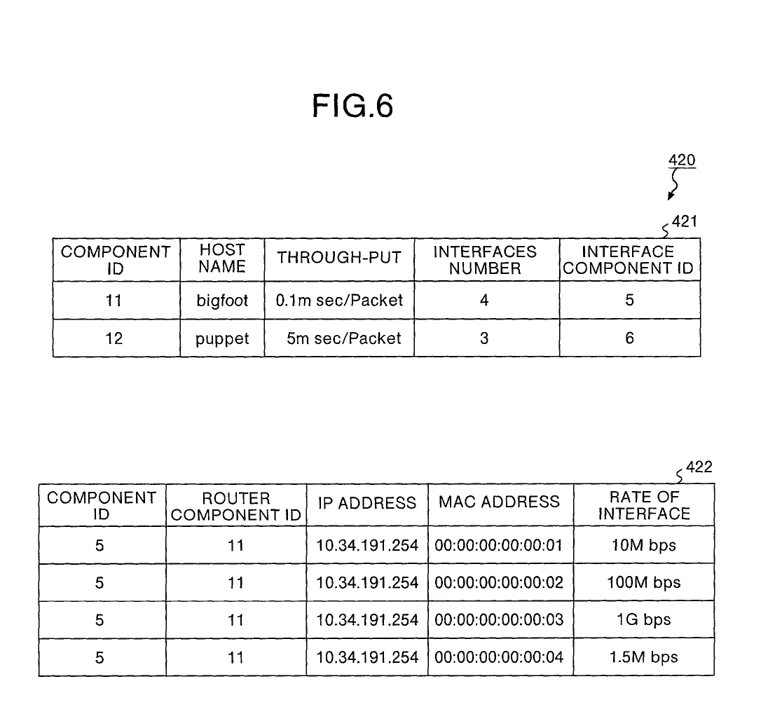

The object-to-be-managed device performance data 420 is constructed of router performance data 421 and interface performance data 422 as illustrated in FIG. 6. The router performance data 421 is data that represents the performance of the router 103 (see FIG. 2), and is constructed of “component ID”, “host name”, “through-put”, “interfaces number”, and “interface component ID” data.

On the other hand, the interface performance data 422 is data that represents the interface performance in the computer network 100, and is constructed of “component ID”, “router component ID”, “IP address”, “MAC address”, and “interface speed” data.

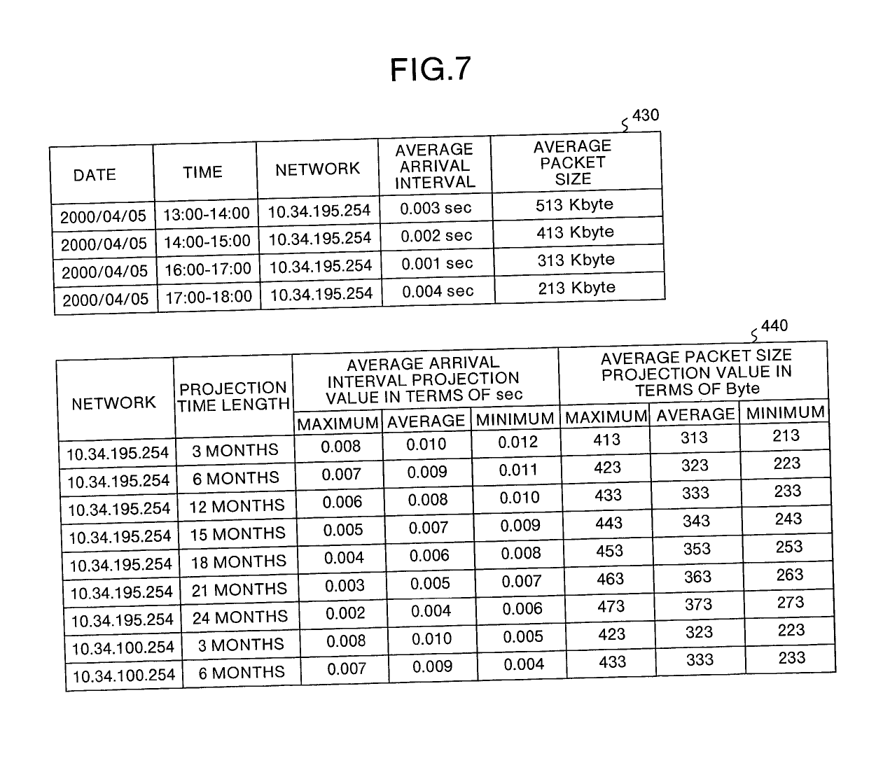

The traffic history data 430 is history data of the traffic (noise traffic 108, noise traffic 109) in the computer network 100 (see FIG. 2) as illustrated in FIG. 7. Concretely, the traffic history data 430 is constructed of “date” on that the traffic occurred, “time” that represents a time zone during that the traffic occurred, “network” that represents the network address, “average arrival interval” of the traffic, and “average packet size” of the traffic.

The traffic for-the-future projection value data 440 is constructed of “network” that represents the addresses of the network that are presently to be projected with respect to, or for, the future, and the “projection time length”, “average arrival interval projection value”, and “average packet size projection value” that each are presently to be projected for the future. Here, the wording “for-the-future projection” means performing projection calculation of the known parameters (the “average arrival interval” and “average packet size” in the traffic history data 430) with use of a mono regression analysis to thereby predict the future amount of traffic (“average arrival interval projection value” and “average packet size projection value”) that will prevail at a point in time as lapsed from the present time onward by the “projection time length”. Regarding the “average arrival interval projection value”, with their degree of reliability having a width of 95%, the maximum, average, and minimum values are respectively determined. Regarding the “average packet size projection value” as well, in the same way, with their degree of reliability having a width of 95%, the maximum, average, and minimum values are respectively determined.

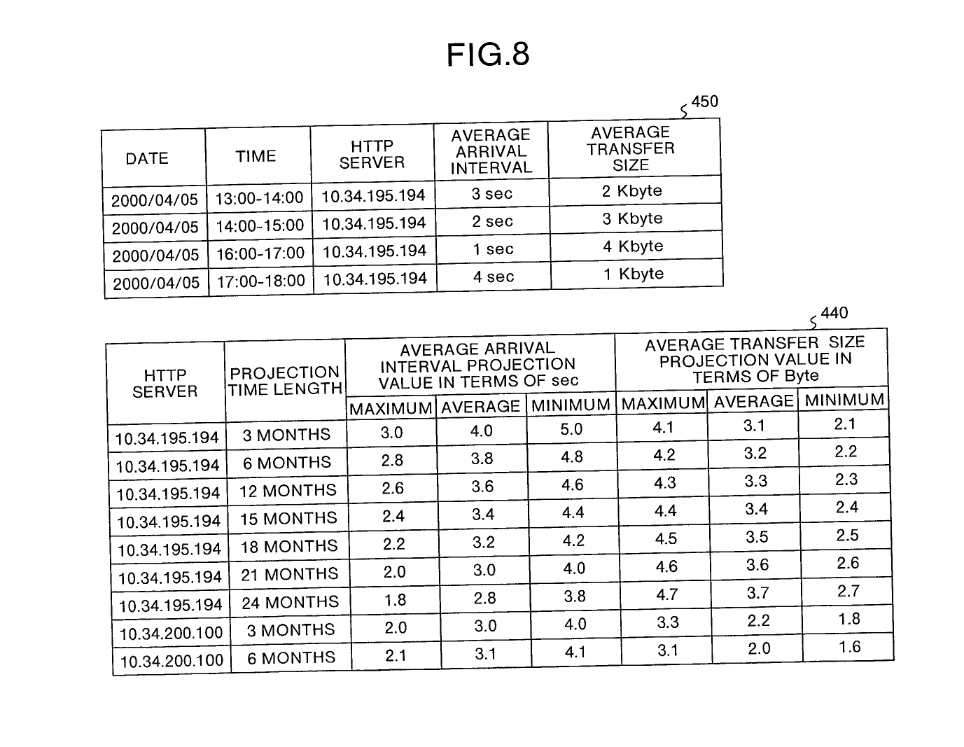

The transaction history data 450 is history data of the transaction (noise transaction 106 and Web transaction 107) in the computer network 100 (see FIG. 2) as illustrated in FIG. 8. In other words, the transaction history data 450 is data that represents the accesses number history to the HTTP server 101.

Concretely, the transaction history data 450 is constructed of “date” on that the traffic occurred, “time” that represents a time zone during that the traffic occurred, “HTTP server” that represents the network address of the HTTP server 101 on that the transaction occurred, “average arrival interval” of the traffic, and “average transfer size” of the traffic.

The transaction projection value data 460 is constructed of “HTTP server” that represents the network addresses of the HTTP 101 and the “projection time length”, “average arrival interval projection value”, and “average transfer size projection value” that each are presently to be projected for the future. Here, the wording “for-the-future projection” means performing projection calculation of the known parameters (the “average arrival interval” and “average transfer size” in the transaction history data 450) with use of mono regression analysis to thereby predict the future number of transactions (the number of accesses) (“average arrival interval projection value” and “average transfer size projection value”) that will occur at a point in time as lapsed from the present time onward by the “projection time length”.

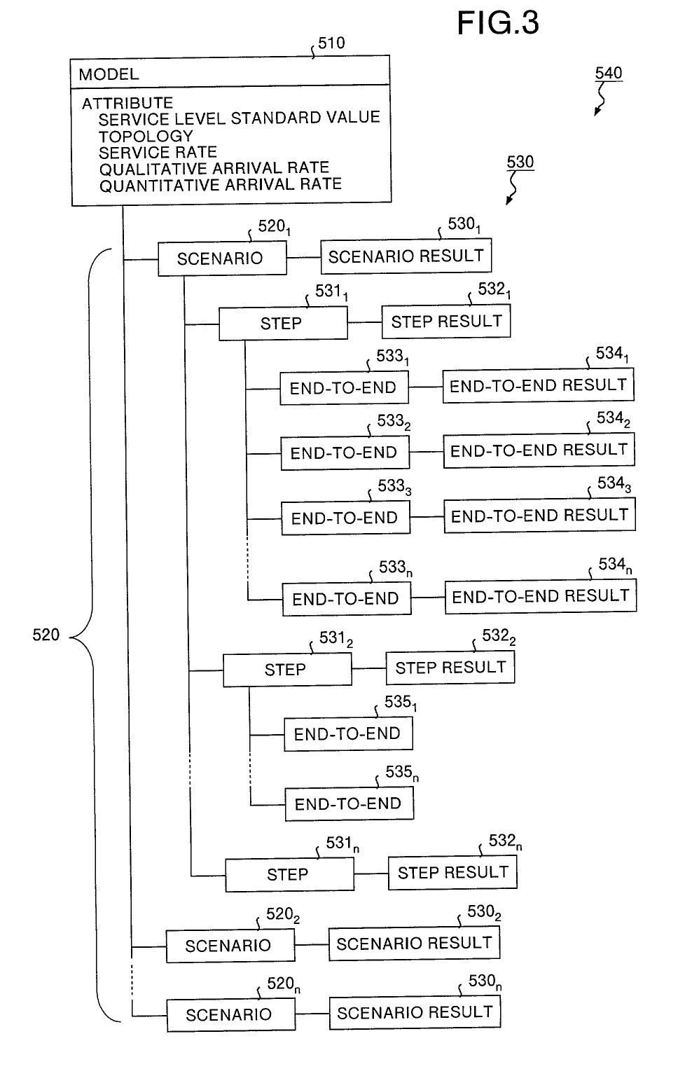

Turning back to FIG. 1, in a simulation data storage section 500, there is stored simulation data 540 illustrated in FIG. 3. The simulation data 540 is constructed of a model 510, scenario 520, and scenario result 530. The model 510 illustrated in FIG. 3 is one that is prepared by the computer network 100 being modeled for its simulation. The attribute thereof is expressed by the service-level standard value (corresponding to the performance standard value as previously referred to), topology, service rate, quantitative arrival rate, and qualitative arrival rate. The scenario 520 is constructed of an n number of scenarios 520₁ to 520ₙ. The scenario result 530 is constructed of an n number of scenario results 530₁ to 530ₙ that correspond to the n number of scenarios 520₁ to 520ₙ.

The scenario 520₁ is constructed of an n number of steps 531₁ to 531ₙ. The step 531₁ is constructed of an n number of End-to-End's. The End-to-End corresponds to a terminal-to-terminal segment in the model 510. The respective simulation results of these End-to-End's 533₁ to 533ₙ are indicated as End-to-End results 534₁ to 534₁. These End-to-End results 534₁ to 534ₙ are handled as step results 532₁.

The step 531₂ is also constructed of an n number of End-to-End's 535₁ to 535ₙ in the same way as in the case of the step 531₁. The simulated results (not illustrated) of these End-to-End's 535₁ to 535ₙ are handled as step results 532₂. Thereafter, in the same way, each of the scenarios 520₂ to 520ₙ has the same construction as in the case of the scenario 520₁. Also, each of the scenario results 530₂ to 530ₙ has the same construction as in the case of the step result 532₁.

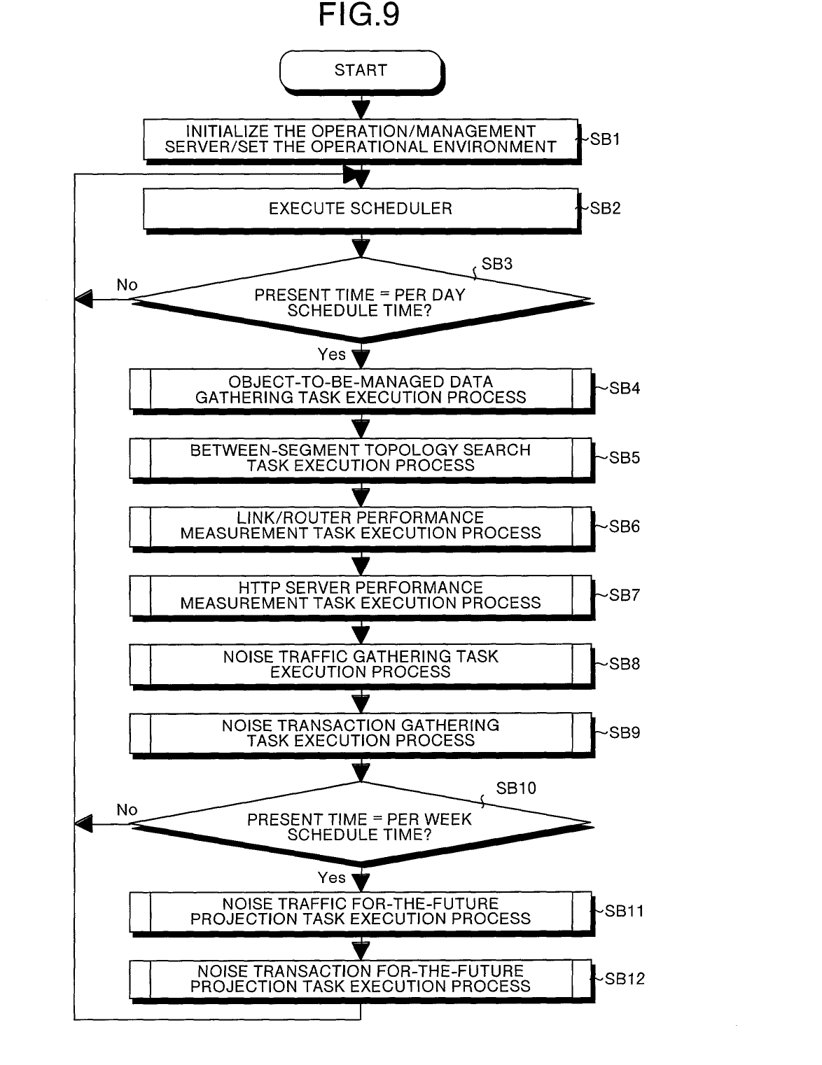

Next, the operation of this embodiment will be explained with reference to FIG. 9 to FIG. 39. FIG. 9 is a flowchart illustrating the operation of the operation/management server 200 illustrated in FIG. 1. In step SB1 illustrated in this figure, the control section 210 illustrated in FIG. 1 performs initialization and setting of the operational environment. In step SB2, the control section 210 starts to execute various kinds of tasks according to the management of the schedule performed by the scheduler 220.

Instep SB3, the control section 210 determines whether the present time falls upon a per-day schedule time. In this case, if the result of the determination is “NO”, the processings in the steps from the step SB2 onward are repeatedly executed. The per-day schedule time referred to here means the execution point in time of a task that is executed once a day. Here, when the result of the determination in step SB3 becomes “YES”, the control section 210 makes the determination result in step SB3 “YES”.

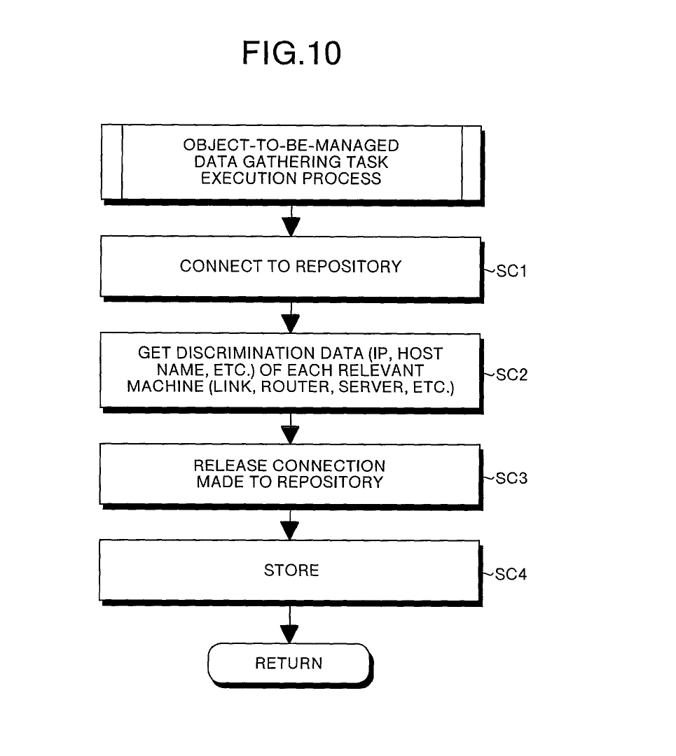

In step SB4, the control section 210 executes an object-to-be-managed data gathering task constituting the parameter-gathering task 230. Namely, in step SC1 illustrated in FIG. 10, the control section 210 connects the operation/management server 200 to the repository 400. In step SC2, the control section 210 gets identification data (IP address, host name) of the machines (link, router, server, etc.) in the computer network 100. This identification data is object-to-be-managed data. In step SC3, the control section 210 releases the connection of the server 200 made with respect to the repository 400. In step SC4, the control section 210 stores the identification data into the model source-material data storage section 401.

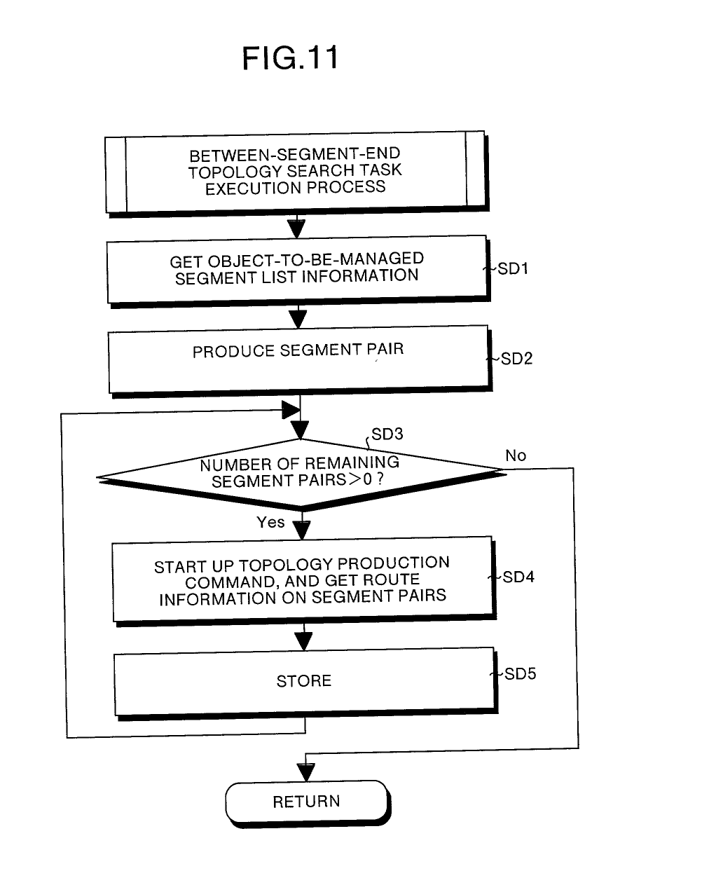

Next, in step SB5 illustrated in FIG. 9, the control section 210 executes a between-segment topology search task, which is a task for searching for the topology between the segments in the computer network 100. Namely, in step SD1 illustrated in FIG. 11, the control section 210 gets the object-to-be-managed segment list information 402 from the repository 400. This object-to-be-managed segment list information 402 is information on a plurality of segments in the computer network 100.

In step SD2, the control section 210 prepares segment pairs that are all combinations between the sources and the destinations from the object-to-be-managed segment list information 402. The number of the segment pairs that are prepared here is “12” that is obtained from the expression “4” (=source)×“3” (=destination, provided that the destination from that the pairs originate is excluded) under the assumption that the total number of segments in the object-to-be-managed segment list information 402 be “4”. In step SD3, the control section 210 determines whether the number of the segment pairs that have not finished being measured is equal to or greater than 1 and it is now assumed that the result of the determination is “YES”. In step SD4, the control section 210 starts up a topology creation command for creating the topology in each segment pair to thereby get the route information on the segment pair from the computer network 100. In step SD5, such route information is stored in the model source-material data storage section 401. Thereafter, the processings in the steps from the step SD3 onward are repeatedly executed.

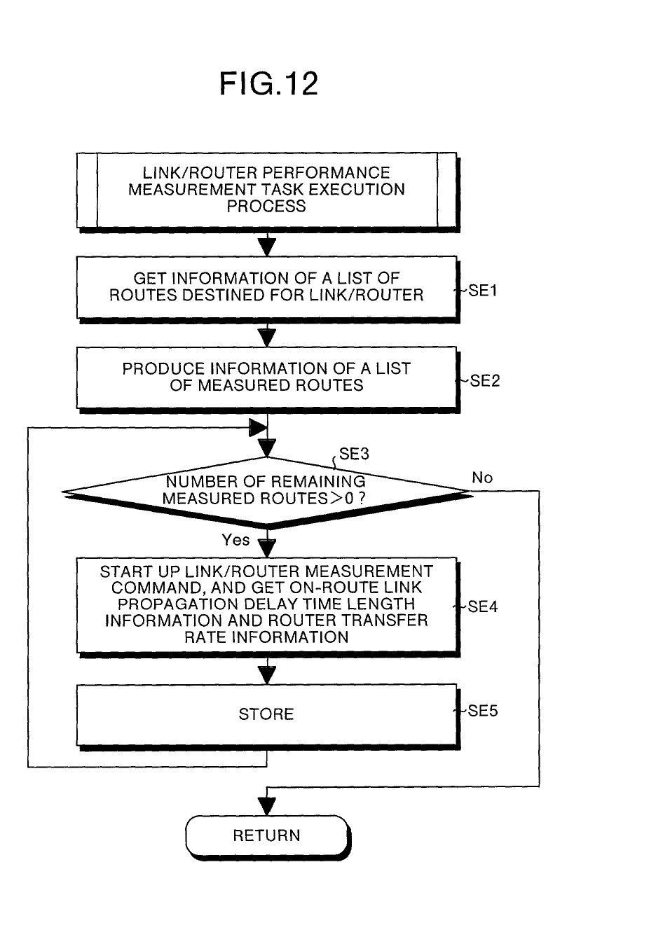

When the determination result in step SD3 becomes “NO”, in step SB6 illustrated in FIG. 9 the control section 210 executes a link/router performance measurement task that constitutes section of the parameter measurement task 240. This link/router performance measurement task is a task for measuring the link/router performance in the computer network 100. In step SE1 illustrated in FIG. 12, the control section 210 gets information on a list of a plurality of routes from a measuring host (not illustrated) to the link routes, from the repository 400. In step SE2, according to that list, the control section 210 creates a list of route information the link/router of that is near to the measuring host (measured-route list information).

In step SE3, the control section 210 determines whether the number of non-measured routes is equal to or greater than 1. In this case, assume that the determination result is “YES”. Then, in step SE4, the control section 210 gets the link propagation delay time length information and router transfer rate information on the relevant routes in the computer network 100 according to the measuring commands (link/router measuring commands). In step SE5, the control section 210 stores this link propagation delay time length information and router transfer rate information into the model source-material data storage section 401. Thereafter, the control section 210 repeatedly executes the processings in the steps from the step SE3 onward.

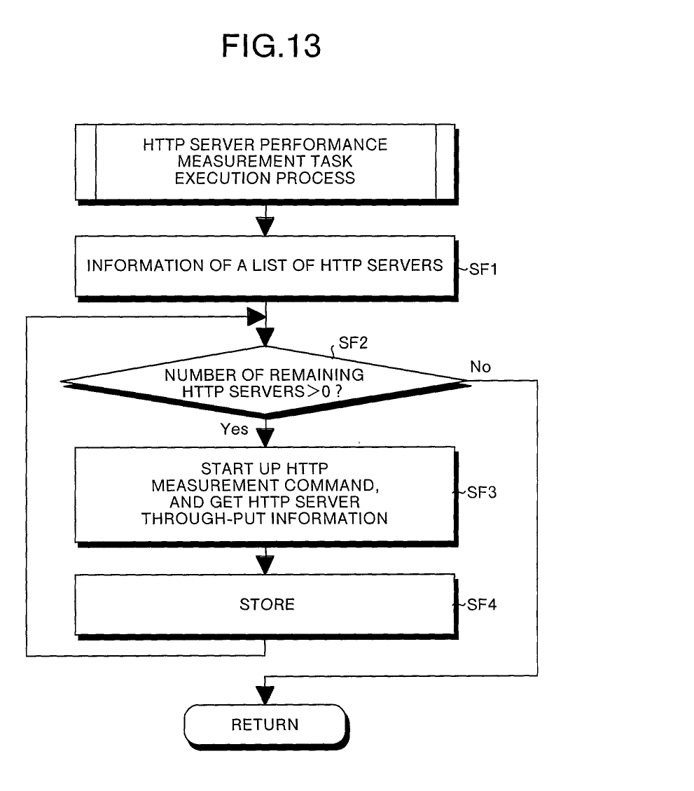

When the determination result of the step SE3 becomes “NO”, in step SB7 illustrated in FIG. 9 the control section 210 executes an HTTP server performance measurement task constituting section of the parameter-measuring task 240. This HTTP server performance measurement task is a task for measuring the performance of the HTTP server in the computer network 100. In step SF1 illustrated in FIG. 13, the control section 210 gets the HTTP server list information 403 from the repository 400. The HTTP server list information 403 is a list of information as to the information (network address, etc.) that regards a plurality of HTTP servers.

In step SF2, the control section 210 determines whether the number of non-measured HTTP servers is equal to or greater than 1, whereby it is now assumed that the result of the determination is “YES”. In step SF3, according to the measuring commands C (HTTP-measuring commands), the control section 210 gets through-put information on the HTTP server in the computer network 100. In step SF4, the control section 210 stores the through-put information on HTTP server into the model source-material data storage section 401. Thereafter, the control section 210 repeatedly executes the processings in the steps from the step SF2 onward.

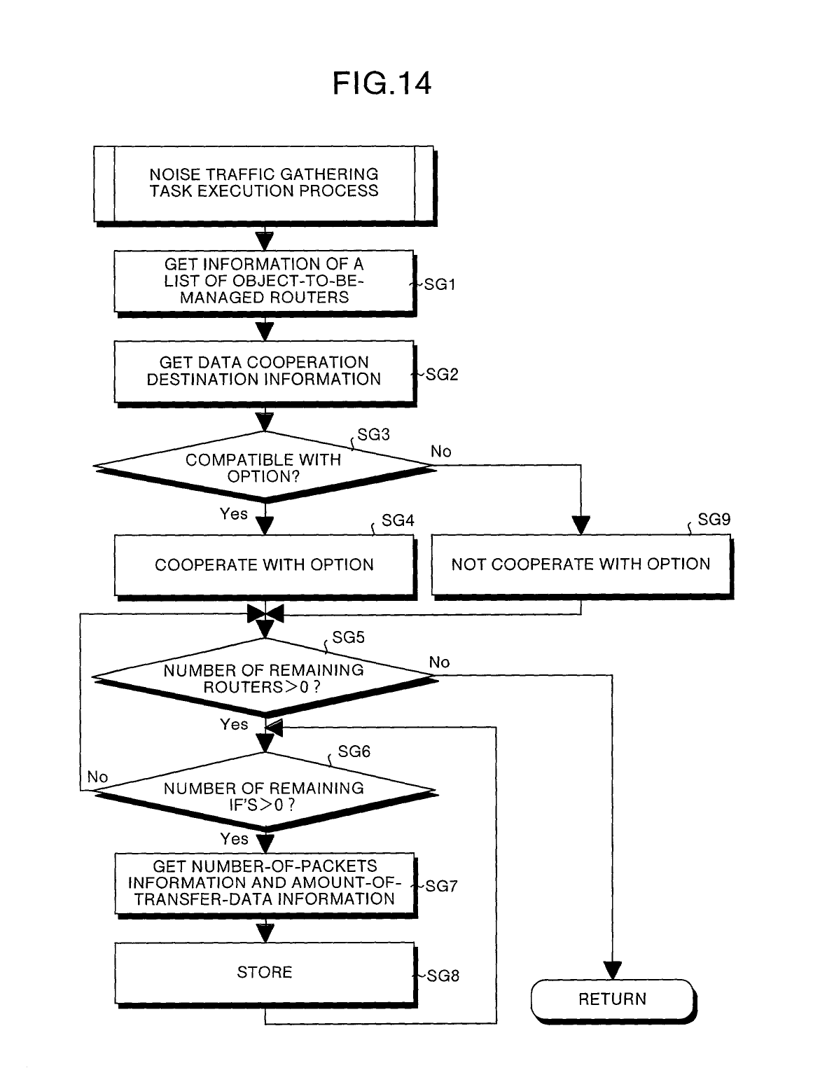

When the result of the determination in the step SF2 becomes “NO”, in step SB8 illustrated in FIG. 9, the control section 210 executes a noise traffic gathering task constituting section of the parameter-gathering task 230. This noise traffic-gathering task is a task for gathering the noise traffic 109 and noise traffic 108 (see FIG. 2) in the computer network 100. In step SG1 illustrated in FIG. 14, the control section 210 gets object-to-be-managed router list information from the model source-material data storage section 401.

In step SG2, the control section 210 gets the data cooperation destination 404 from the repository 400. The data cooperation destination information 404 so referred to here means information that is used for the information 404 to have cooperation with the data in an option machine (not illustrated). In step SG3, the control section 210 determines whether the operation/management server 200 has compatibility with the option. In case the result of the determination is “YES”, the control section 210 performs its cooperation with the option machine. On the other hand, in case the result of the determination is “NO”, in step SG9 the control section 210 doesn't cooperate with the option machine.

In step SG5, the control section 210 determines whether in the object-to-be-managed router list information the number of information non-gathered routers is equal to or greater than 1. In this case, the result of the determination is assumed to be “YES”. In step SG6, the control section 210 determines whether the number of interfaces regarding the routers is equal to or greater than 1. In case the result of the determination is “NO”, the processings in the steps from the step SGS onward are repeatedly executed.

In this case, assume that the determination result of the step SG6 is “YES”. Then, in step SG7, the control section 210 gathers packets number information and transfer data amount information from the repository 400 as the noise traffic. In step SG8, the control section 210 stores the packets number information and transfer data amount information into the model source-material data storage section 401. Thereafter, the processings in the steps on and after the step SG5 are repeatedly executed.

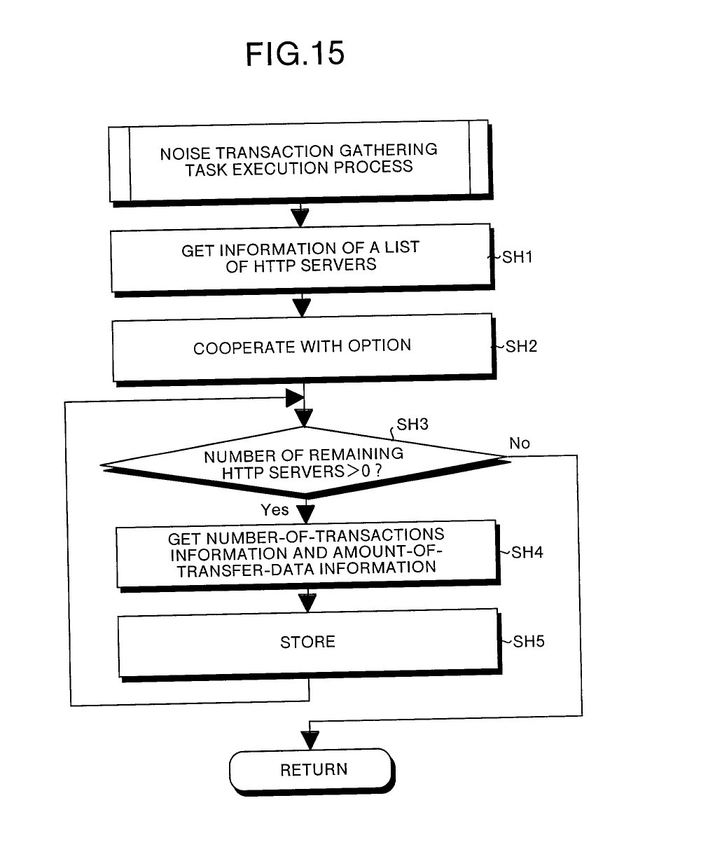

When the determination result of the step SG5 becomes “NO”, in step SB9 illustrated in FIG. 9 the control section 210 executes a noise transaction data gathering task that constitutes section of the parameter-gathering task 230. This noise transaction data gathering task is a task for gathering the noise transaction 106 (see FIG. 2) in the computer network. In step SH1 illustrated in FIG. 15, the control section 210 gets the HTTP server list information from the model source-material data storage section 401.

In step SH2, the control section 210 performs its cooperation with an option machine not illustrated. In step SH3, the control section 210 determines whether in the HTTP server list information the number of information non-gathered HTTP servers is equal to or greater than 1. In this case, it is assumed now that the result of the determination is “YES”. In step SH4, the control section 210 gets transactions number information and data transfer amount information as the noise transaction. In step SH5, the control section 210 stores the transactions number information and data transfer amount information into the model source-material data storage section 401. Thereafter, the processings in the steps on and after the step SH3 are executed.

When the determination result of the step SH3 becomes “NO”, in step SB10 illustrated in FIG. 9 the control section 210 determines whether the present time falls upon a per-week schedule time. In case the result of the determination is “NO”, the processings on and after the step SB2 are repeatedly executed. The wording “per-week schedule time” referred to here as such means the execution point in time of a task that is executed once a week.

When the determination result of the step SB10 becomes “YES”, in step SB11, the control section 210 executes a noise traffic for-the-future projection task that constitutes section of the for-the-future projection task 250. This noise traffic for-the-future projection task is a task that according to the gathered traffic history data 430 performs for-the-future projection of the noise traffic data.

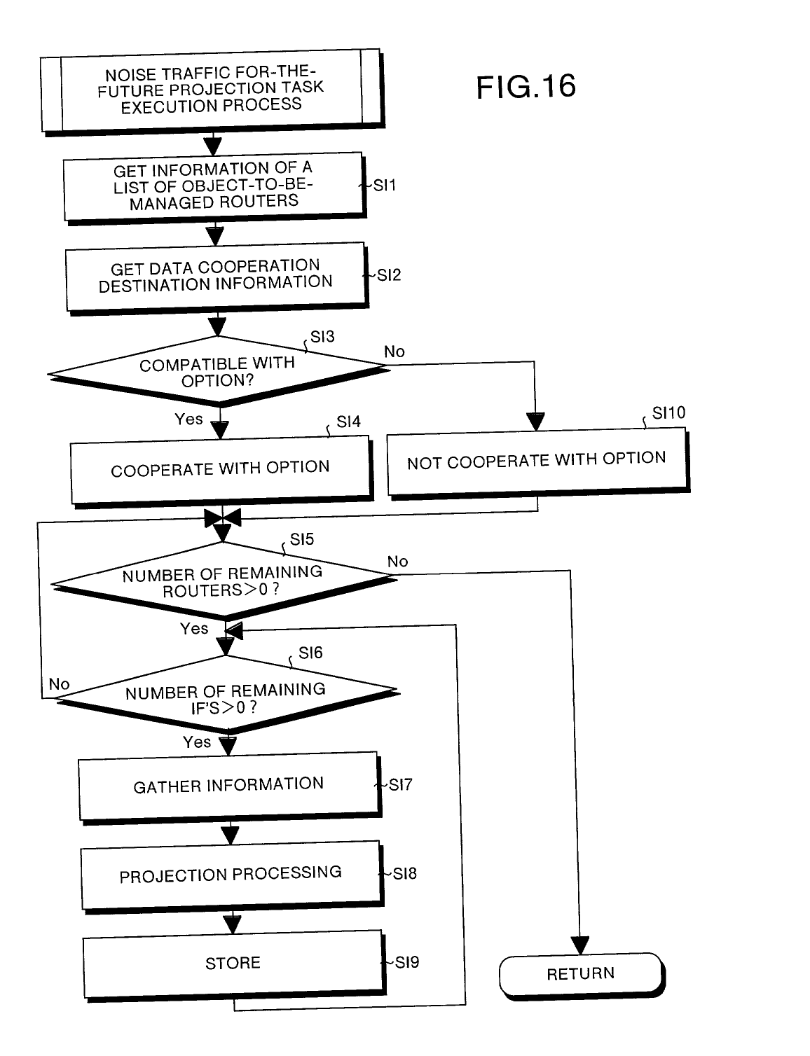

In step SI1 illustrated in FIG. 16, the control section 210 gets object-to-be-managed router list information from the model source-material data storage section 401. In step SI2, the control section 210 gets data cooperation destination information from the model source-material data storage section 401. The wording “data cooperation destination” referred to here as such means that the control section 210 performs its cooperation with the data in an option machine (not illustrated). In step SI3, the control section 210 determines whether the operation/management server 200 has compatibility with the option. In case the determination result is “YES”, the control section 210 cooperates with the option machine. On the other hand, in case the determination result of the step SI3 is “NO”, in step SI10 the control section 210 doesn't cooperate with the option machine.

Instep S15, the control section 210 determines whether in the object-to-be-managed router list information the number of information non-gathered routers is equal to or greater than 1. In this case, it is assumed that the result of the determination is “YES”. In step SI6, the control section 210 determines whether the number of interfaces regarding the routers is equal to or greater than 1. In case the result of the determination is “NO”, the processings on and after the step SI5 are repeatedly executed.

In this case, it is assumed now that the determination result of the step SI6 is “YES”. Then, in step SI7, the control section 210 gathers the packets number information and transfer data amount information as the noise traffic from the model source-material data storage section 401 retroactively to the point in time that precedes two years at maximum from the present day of the week. In step SI8, the control section 210 applies the mono repression analysis method to the past noise traffic, thereby performing projection calculation of it within an prediction period of time (e.g. 3 months, 6 months, 9 months, 12 months, 15 months, 18 months, 21 months, or 24 months).

In this projection calculation, regarding the noise traffic information, there are determined three projection values of an upper-limit value, average value, and lower-limit value, the degree of reliability on that has a width of 95%. In step SI9, the control section 210 stores the result of the projection calculation into the model source-material data storage section 401 as the traffic for-the-future projection value data 440. Thereafter, the processings on and after the step SI6 are repeatedly executed.

When the determination result of the step SI5 becomes “NO”, in step SB12 illustrated in FIG. 9 the control section 210 executes a noise transaction for-the-future projection task that constitutes section of the for-the-future projection task 250. This noise transaction for-the-future projection task is a task that according to the gathered transaction history data 450 performs future prediction of the noise transaction.

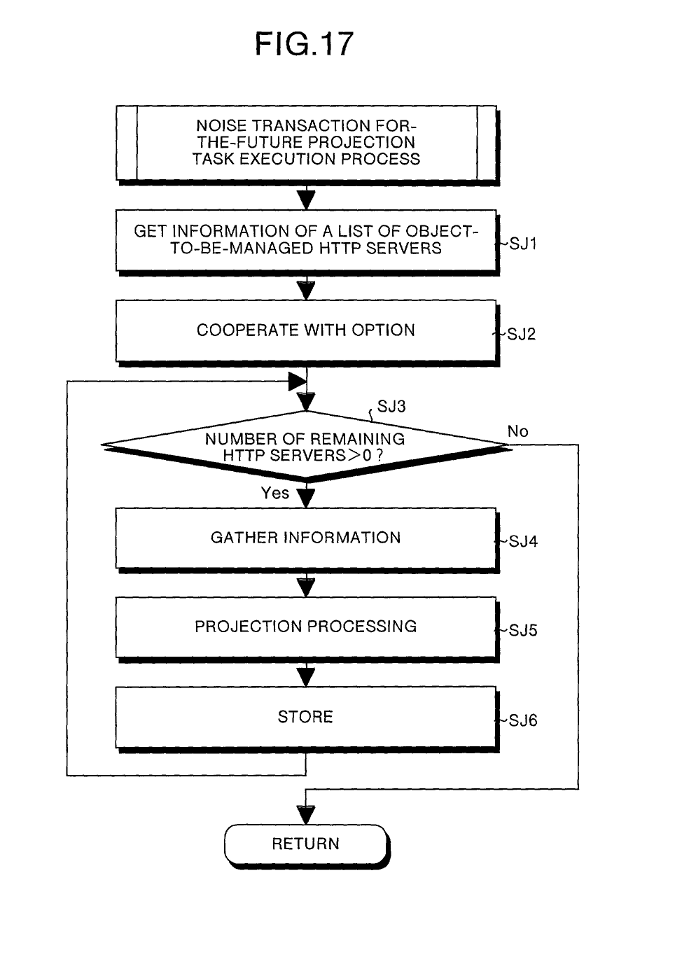

In step SJ1 illustrated in FIG. 17, the control section 210 gets HTTP server list information from the model source-material data storage section 401. In step SJ2, the control section 210 performs its cooperation with an option machine not illustrated. In step SJ3, the control section 210 determines whether in the HTTP server list information the number of information non-gathered HTTP servers is equal to or greater than 1, and in this case, it is assumed that the result of the determination is “YES”. In step SJ4, the control section 210 gathers the transactions number information and transfer data amount information as the noise transaction from the model source-material data storage section 401 retroactively to the point in time that precedes two years at maximum from the present day of the week.

In step SJ5, the control section 210 applies the mono repression analysis method to the past noise transaction, thereby performing projection calculation of it within an prediction period of time (e.g. 3 months, 6 months, 9 months, 12 months, 15 months, 18 months, 21 months, or 24 months).

In this projection calculation, regarding the noise transaction information, there are determined three projection values of an upper-limit value, average value, and lower-limit value, the degree of reliability on that has a width of 95%. In step SJ6, the control section 210 stores the result of the projection calculation into the model source-material data storage section 401 as the transaction projection value data 460. Thereafter, the processings on and after the step SJ3 are repeatedly executed. When the determination result of the step SJ3 becomes “NO”, the processings on and after the step SB2 illustrated in FIG. 9 are repeatedly executed.

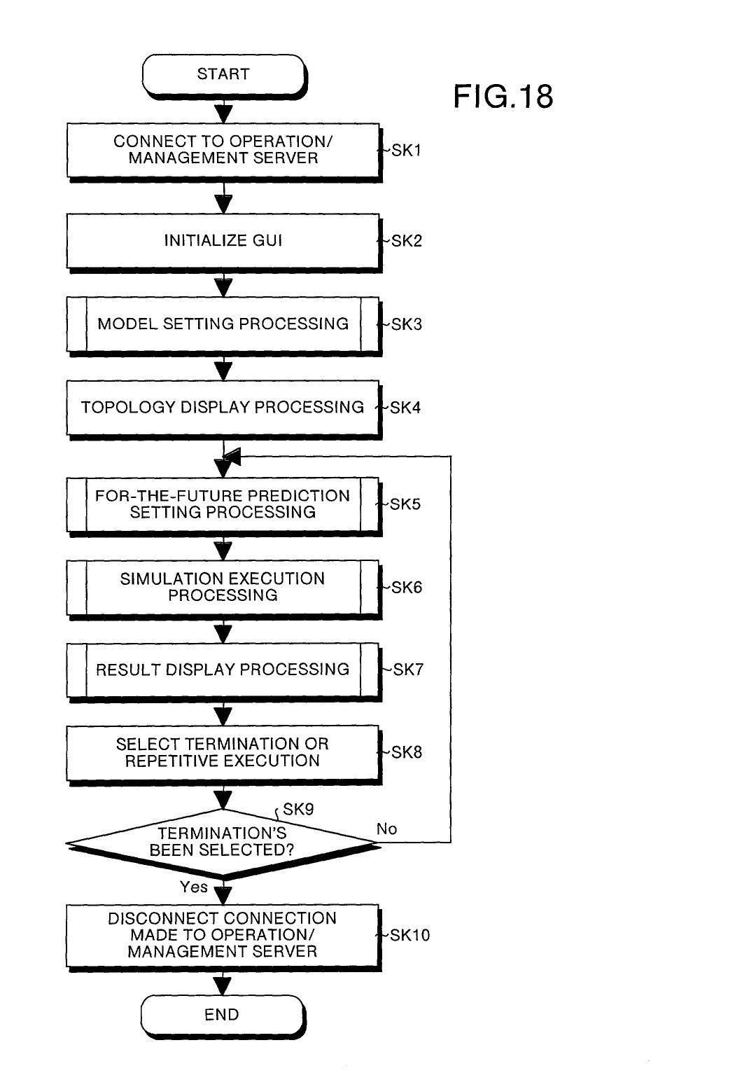

Next, the operation of the operation/management client 300 illustrated in FIG. 1 will be explained with reference to a flowchart illustrated in FIG. 18. In step SK1 illustrated in this figure, the user inputs a command from the user terminal 600 that causes the control section 210 to connect the operation/management client 300 to the operation/management server 200. In step SK2, the input/output section 320 initializes the GUI (Graphical User Interface).

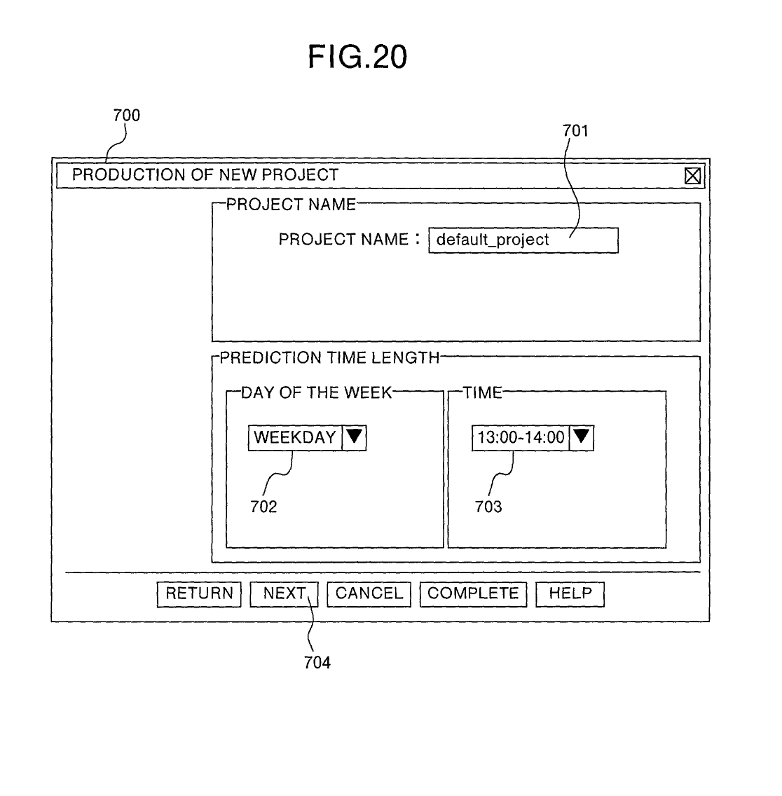

In step SK3, a model-setting piece of processing for setting the model used when simulation is performed is executed. Namely, when a model-setting instruction is issued through the operation of the user terminal 600 illustrated in FIG. 1, the model creation wizard 321 is started up. Thereby, on the display 610, there is displayed an image screen 700 illustrated in FIG. 20.

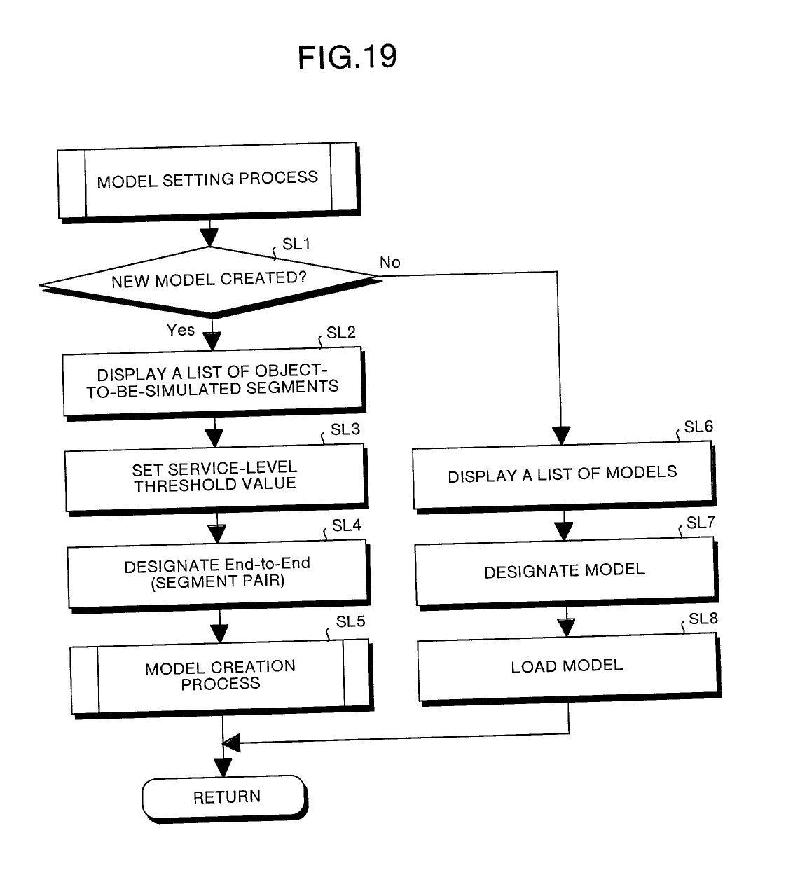

In step SL2 illustrated in FIG. 19, the model creation/management section 311 determines whether a new-model-creation instruction has been issued from the user terminal 600. Then, the user's inputting operation is performed as follows. Namely, the “default # project” is input to the project's name input column 701 illustrated in FIG. 20 as the project's name. (It is to be noted that, here in this specification, the underbars in the drawing are each described as “#”, and, on the following pages as well, that is the same). The “weekday” is input to the day-of-the-week input column 702 as the day of the week for (for-the-future) prediction period of time. “13:00-14:00” is input to the time input column 703 as the time zone. Thereafter, when a next image-screen transition button 704 is depressed, the model creation/management section 311 operates to make the result of the determination of the step SL1 “YES”.

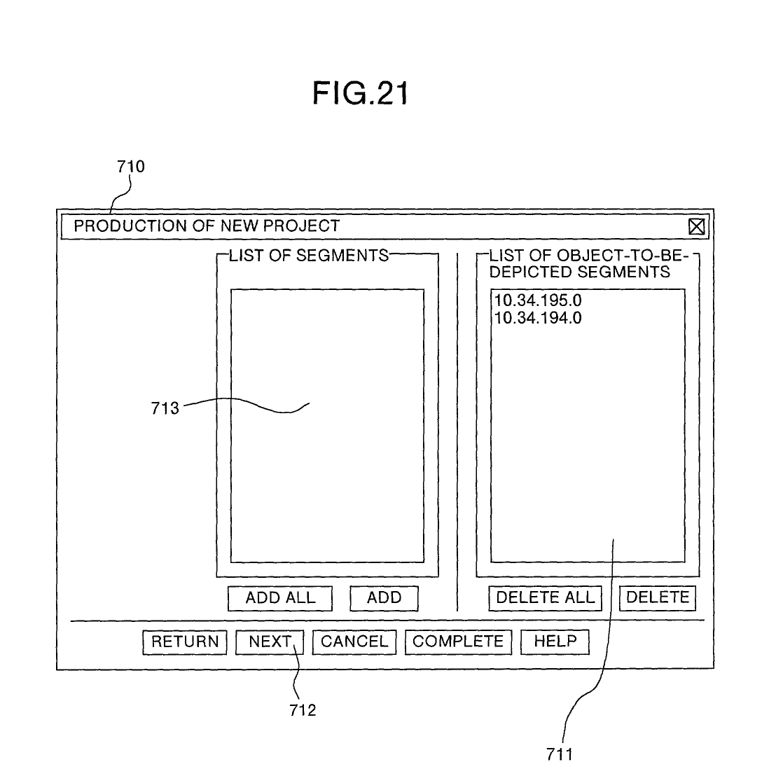

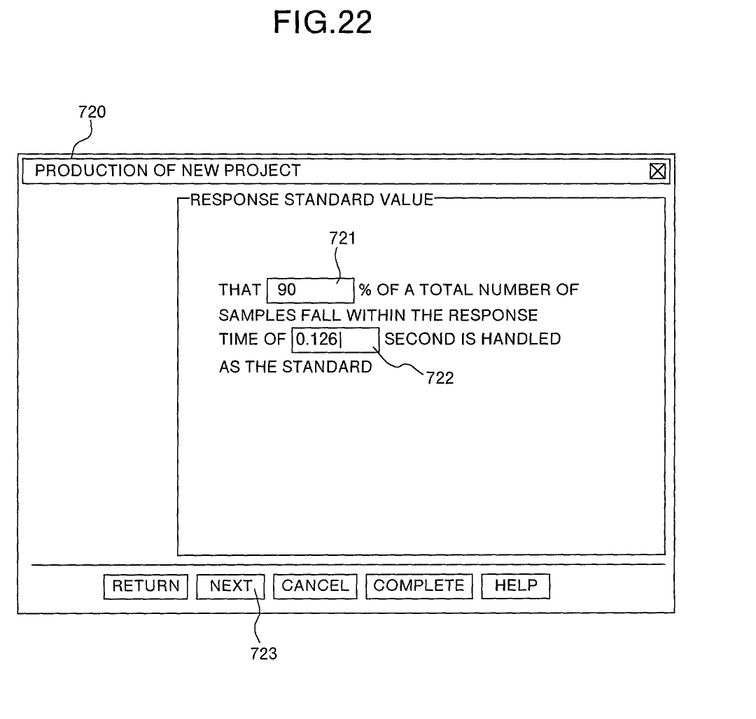

As a result of this, in step SL2, the model creation/management section 311 causes display of an image screen 710 illustrated in FIG. 21. Simultaneously, the model creation/management section 311 causes the user to select an object-to-be-simulated segment list (an object-to-be-depicted segment list 711) from an object-to-be-managed segment list (a segment list 713) by means of the user terminal 600. The object-to-be-simulated segment list that is so referred to here means a segment becoming an object to be simulated, which falls under the segments becoming the objects to be managed in the computer network 100 (see FIG. 2). Here, when a next image-screen transition button 712 is depressed, on the display 610 there is displayed an image screen 720 illustrated in FIG. 22. This image screen 720 is an image screen for setting the threshold value of the service level (performance standard)

In step SL3, the “90”% is input to the percent data input column 721 and the “0.126” second is input to the standard response time input column 722, respectively, by means of the user terminal 600. Namely, in this case, that 90% of a total number of samples that is concerned with the transactions in the segment between a pair of segment ends designated in step SL4 as later described falls within the response time length of 0.126 second is handled as the standard of the service level. The “a total number of samples” so referred to here means a total number of the samples (each of that is the response time length (=round-trip time length)).

For example, in the segment pair, in case a transaction occurs at the arrival rate of one piece per second, assume now that simulation is executed for a time period of 10 seconds. Then, it is possible to obtain 10 pieces of samples (=the response time lengths) on average. The total number of samples in this case is “10”. Accordingly, in the case of the standard of the service level, if at least “9” samples (90%) of this “10” samples each fall within a time period of 0.126 second, the simulated model network satisfies the service level. In step SL4, by means of the user terminal 600, the segment pair (End-to-End) that is an object to be simulated is designated. The segment pair (End-to-End) is one terminal (End) and the other terminal (End) that constitute one relevant segment.

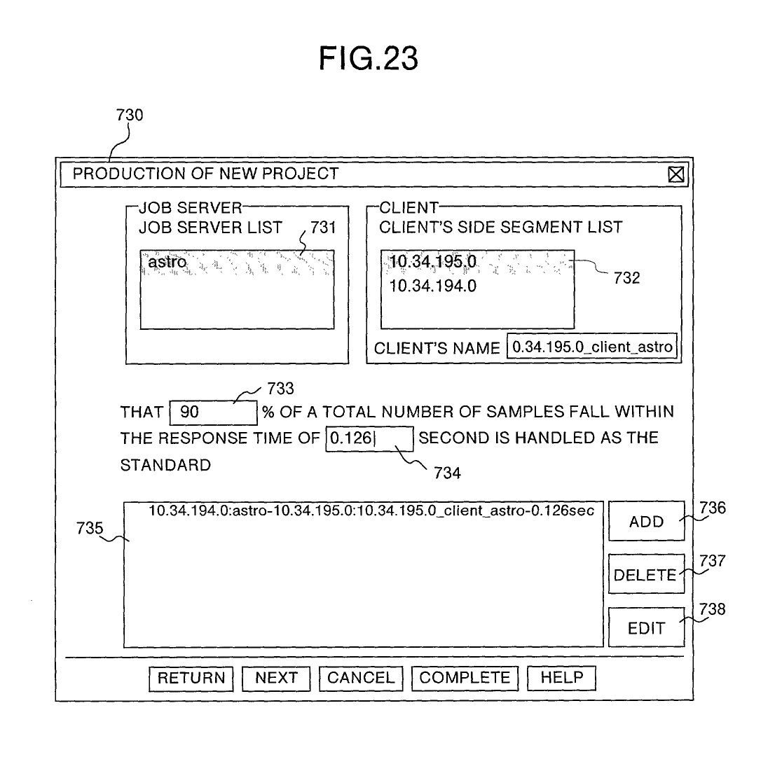

Namely, when a next image screen transition button 723 is depressed, on the display 610 there is displayed an image screen 730 illustrated in FIG. 23. Using this image screen 730, the user designates a segment pair. In this case, the user designates the “astro” (corresponding to the HTTP server 101: see FIG. 2) representing one of the segment pair from an “on-the-job” server list 732 and also designates the “10.34.195.0” (corresponding to the LAN 104: see FIG. 2) representing the other of the segment pair from a client' side segment list 732. In this case, at an area located under the client's side segment list 732, the “0.34.195.0#client#astro” (corresponding to the Web client 105: see FIG. 2) is displayed as the client's name. Also, in a percent data display column 733, the “90.0.”% (see FIG. 22) that was input by the user on the image screen 720 illustrated in FIG. 22 is displayed as a default value. In a standard response time display column 734, the “0.126” second (see FIG. 22) that was input by the user on the image screen 720 illustrated in FIG. 22 is displayed as a default value. It is to be noted that, in case changing these default values, post-change values are input by the user. As a result of this, those default values are substituted. Also, in a display column 735, information of the segment pair and information of the threshold value of the service level are displayed. Also, in the image screen 730, an “add” button 736, “delete” button 737, and “edit” button 738 are displayed.

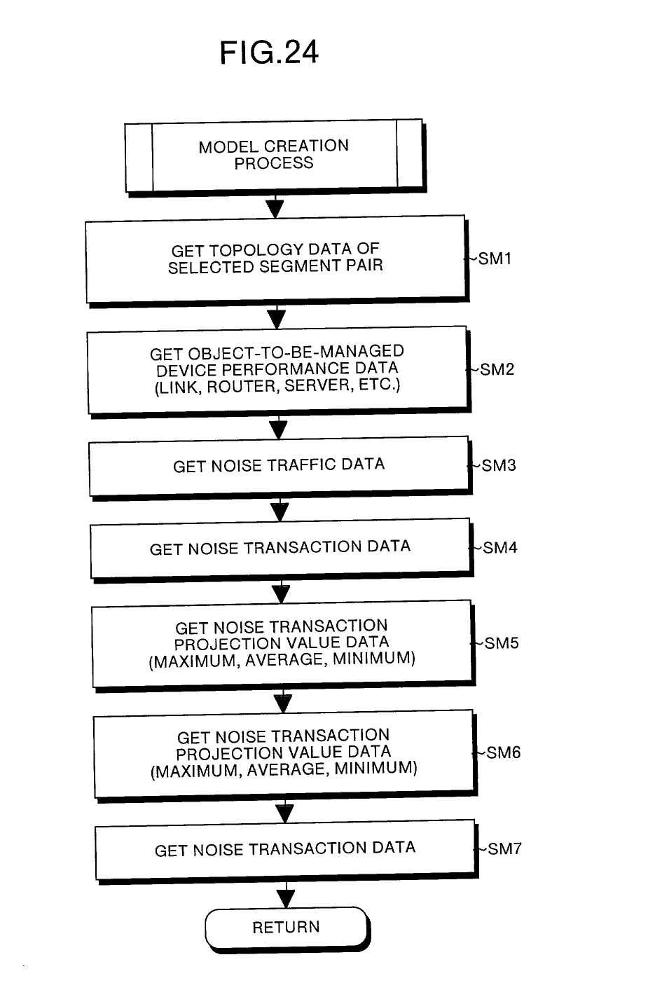

In step SL5 illustrated in FIG. 19, the model creation/management section 311 creates a model according to the segment pair and the threshold value of the service level. Namely, in step SM1 illustrated in FIG. 24, the model creation/management section 311 gets the topology of a selected segment pair from the model source-material data storage section 401 (the topology data 410). In step SM2, the model creation/management section 311 gets an object-to-be-managed device performance data from the model source-material data storage section 401 (the object-to-be-managed device performance data 420) via the operation/management server 200.

In step SM3, the model creation/management section 311 gets noise traffic data from the model source-material data storage section 401 (the traffic history data 430) via the operation/management server 200. Instep SM4, the model creation/management section 311 gets noise transaction data from the model source-material data storage section 401 (the transaction history data 450) via the operation/management server 200. In step SM5, the model creation/management section 311 gets traffic for-the-future projection data 440 via the operation/management server 200. In step SM6, the model creation/management section 311 gets transaction for-the-future projection data 460 via the operation/management server 200.

On the other hand, in case the determination result of the step SL1 illustrated in FIG. 19 is “NO”, in step SL6 a list of already prepared models 510 (see FIG. 3) is displayed on the display 610. In step SL7, a desired model is designated from among the list of models. In step SL8, the model creation/management section 311 loads the model designated in the step SL7 thereinto from the simulation data storage section 500.

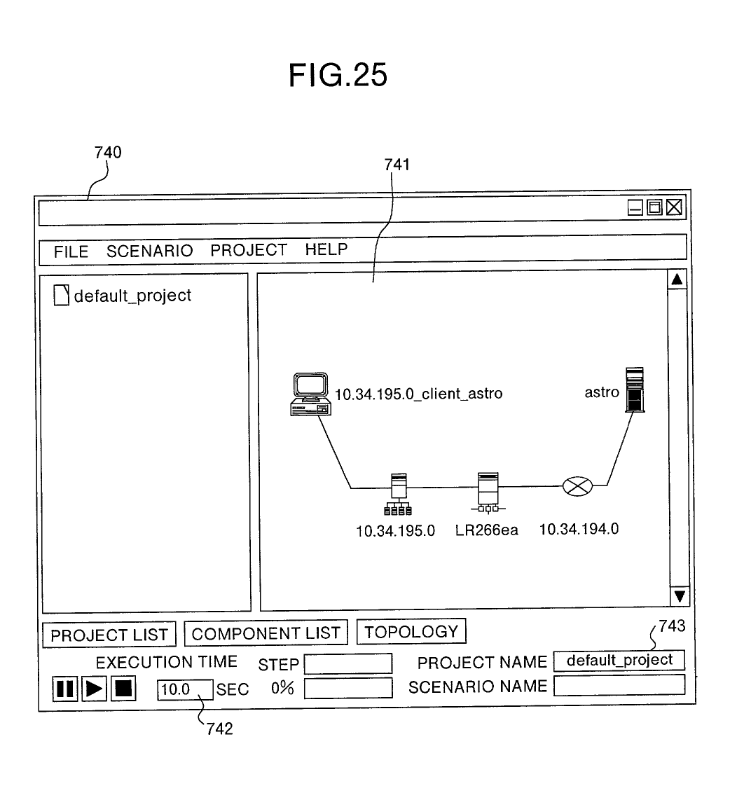

Next, in step SK4 illustrated in FIG. 18, the topology display window 323 is started up, whereby, on the display 610, there is displayed an image screen 740 illustrated in FIG. 25. In a topology display column 741 of this image screen 740, there is displayed a topology corresponding to the computer network 100 illustrated in FIG. 2. In an execution time display column 742, there is displayed an execution length of time for performing the simulation. In a project name display column 743, there is displayed a projection name.

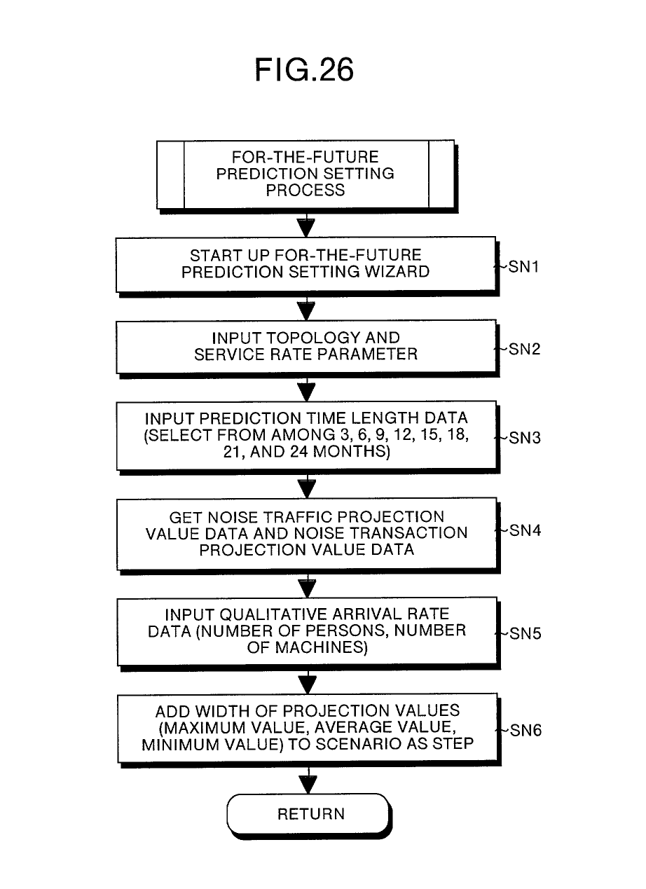

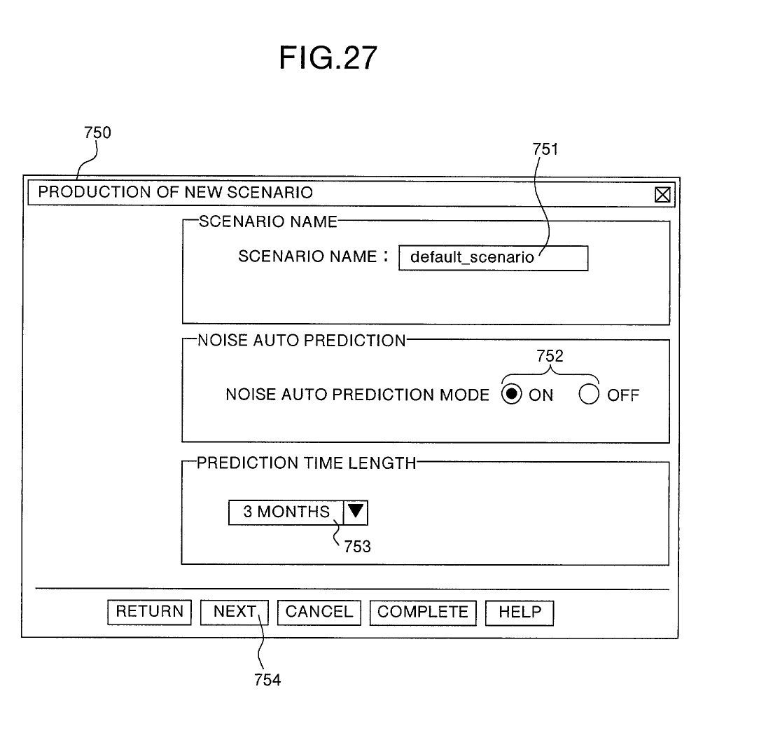

Next, in step SK5 illustrated in FIG. 18, setting for future prediction that is made with respect to the computer network 100 is performed according to the future prediction scenario. Namely, in step SN1 illustrated in FIG. 26, the scenario creation/management section 312 starts up the future prediction wizard 322. As a result of this, an image screen 750 illustrated in FIG. 27 is displayed on the display 610.

In step SN2, the topology and service rate (the service level) of the status quo of the relevant network are brought in. In step SN3, inputting is performed with respect to the prediction length or period of time. Concretely, the user selects an prediction period of time (in this case 3 months) from among a plurality of prediction periods of time (e.g. 3 month, 6 months, 9 months, 12 months, 15 months, 18 months, 21 months, and 24 months) that are prepared in an prediction time-length selection box 753 illustrated in FIG. 27. In an image screen 750, illustration is made of a scenario name input column 751, noise auto prediction mode selection button 752, and next image-screen transition button 754.

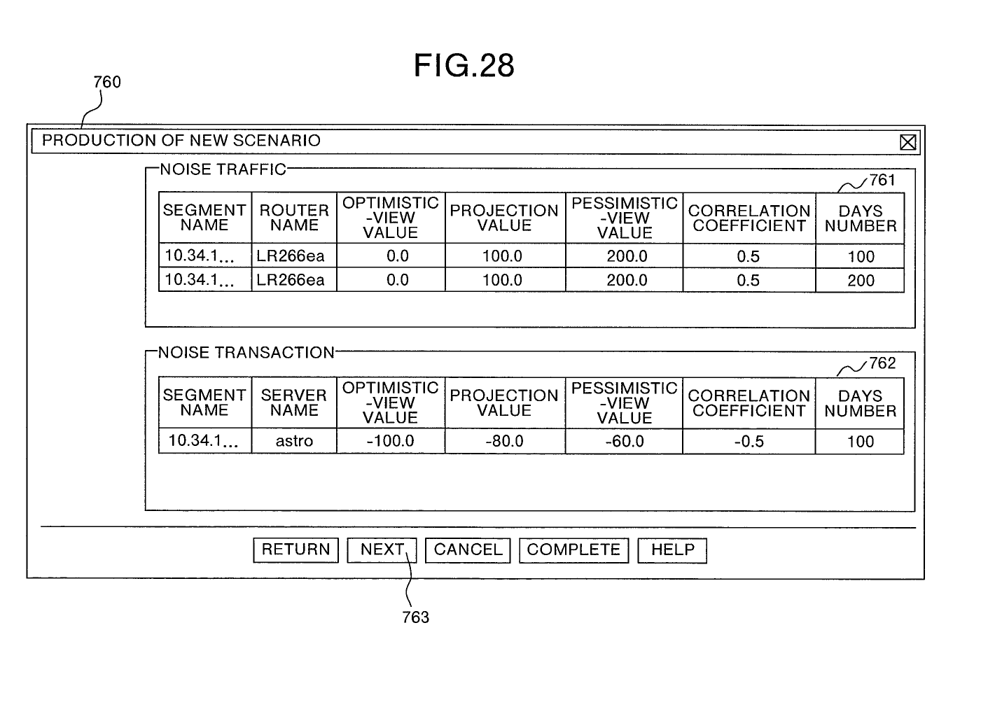

In step SN4, the scenario creation/management section 312 gets the traffic for-the-future projection value data 440 and transaction projection value data 460 from the model source-material data storage section 401 via the operation/management server 200. As a result of this, on the display 610, there is displayed an image screen 760 illustrated in FIG. 28. In a noise traffic display column 761 of this image screen 760, the calculated results (lower-limit value, average value, and upper-limit value) of the projection values of the traffic history data 430 are displayed in units of a segment.

The “optimistic-view value” corresponds to the lower-limit value (minimum value) of the calculated results of the projection values, the “projection value” corresponds to the average value of the calculated results of the projection values, and the “pessimistic-view value” corresponds to the upper-limit value (maximum value) of the calculated results of the projection values. The “correlation coefficient” is a barometer for representing the degree of reliability on the calculated results of the projection values and its value ranges from −1 to 1. The more the absolute value of the correlation coefficient approaches to 1, the higher the degree of reliability is. The “days number” corresponds to the history days number included in the traffic history data 430 that was used for calculation for the projection values.

In a noise transaction display column 762, the calculated results (lower-limit value, average value, and upper-limit value) of the projection values of the transaction history data 450 are displayed in units of a segment. The “optimistic-view value” corresponds to the lower-limit value (minimum value) of the calculated results of the projection values, the “projection value” corresponds to the average value of the calculated results of the projection values, and the “pessimistic-view value” corresponds to the upper-limit value (maximum value) of the calculated results of the projection values. The “correlation coefficient” is a barometer for representing the degree of reliability on the calculated results of the projection values and its value ranges from −1 to 1. The more the absolute value of the correlation coefficient approaches to 1, the higher the degree of reliability is. The “days number” corresponds to the history days number included in the transaction history data 450 that was used for calculation for the projection values.

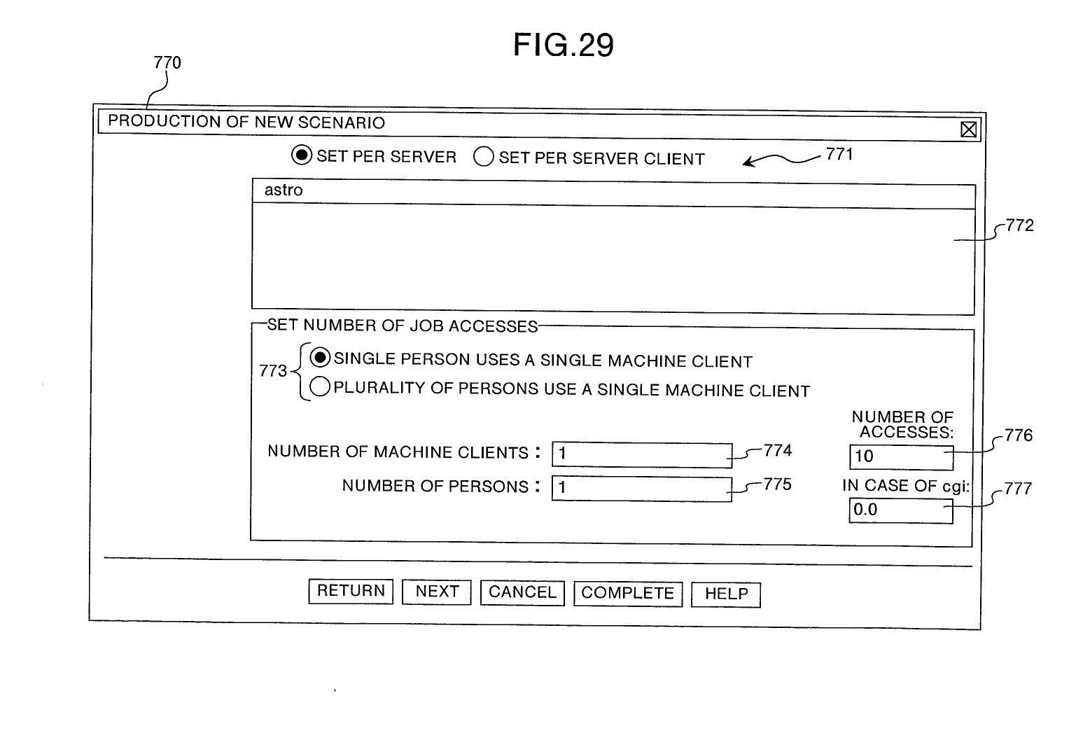

In step SN5, the qualitative arrival rate data is input by the user with use of an image screen 770 illustrated in FIG. 29. In this image screen 770, there are displayed a setting selection column 771, server name display column 772, qualitative arrival rate data (clients number, persons number) input columns 774, 775, accesses number input column 776, and input column 777.

In step SN6, the model creation/management section 311 adds the three calculated results (lower-limit value, average value, and upper-limit value) of the projection values in each of the traffic for-the-future projection value data 440 and transaction projection value data 460 to the future prediction scenario, as steps.

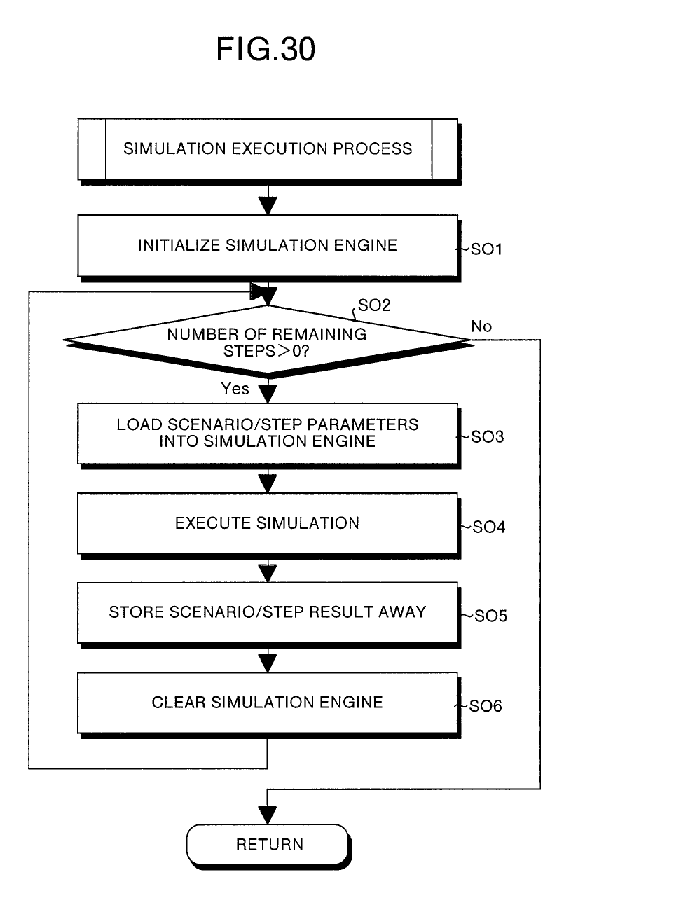

In step SK6 illustrated in FIG. 18, the simulation control section 313 (see FIG. 1) executes the simulation. Namely, in step S01 illustrated in FIG. 30, the simulation control section 313 initializes the simulation engine 314. In step S02, the simulation control section 313 determines whether the number of steps (the remaining steps) with respect to that simulation should be performed is equal to or greater than 1. The “steps” so referred to here mean the steps 531₁ to 531₃ (not illustrated) illustrated in FIG. 3. In this case, the simulation control section 313 makes the result of the determination in the step S02 “YES”.

In step S03, the simulation control section 313 reads the parameters (topology, service rate, qualitative arrival rate, and quantitative arrival rate) corresponding to the step 531₁ to 531₃ (see FIG. 22) from the simulation data storage section 500, and loads these parameters into the simulation engine 314. Thereby, the simulation engine 314 executes the simulation.

In step SO5, the simulation control section 313 causes the simulated results of the simulation to stay away in the simulation data storage section 500 as the step results 5321 to 5322 (see FIG. 3). In step S06, the simulation control section 313 clears the simulation engine 314. Thereafter, the processings on and after the step S02 are repeatedly executed. During this repetition execution, when the determination result of the step S02 becomes “NO”, the simulation control section 313 terminates a series of the processings.

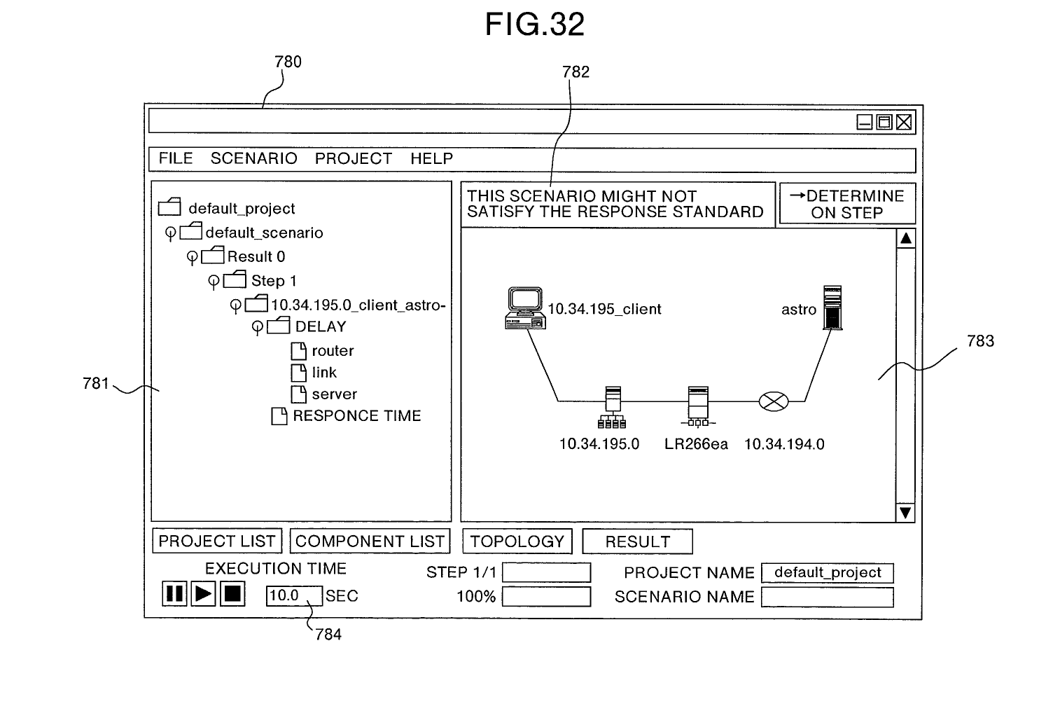

Next, in step SK7 illustrated in FIG. 18, the result creation/management section 315 starts up the result display window 324 and thereby executes a piece of processing for displaying the simulated result on the display 610. In this processing, on the display 610, there is displayed an image screen 780 illustrated in FIG. 32.

In this image screen 780, in a navigation tree display column 781 there is displayed the navigation tree 325 (see FIG. 1). In a result display column 782, there is displayed the result of whether the simulated result based on the scenario (in this case the future prediction scenario) satisfies the response standard (performance standard) (in this case doesn't satisfy). In a topology display column 783, there is displayed the topology. The execution length of time for executing the simulation is displayed in an execution time display column 774.

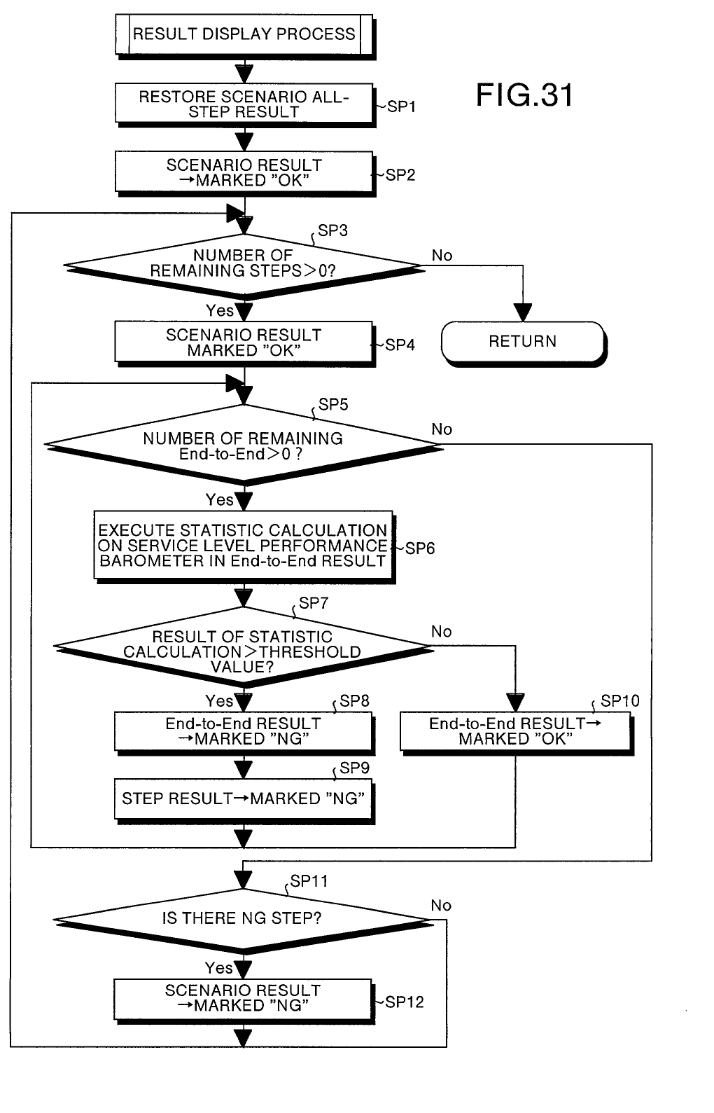

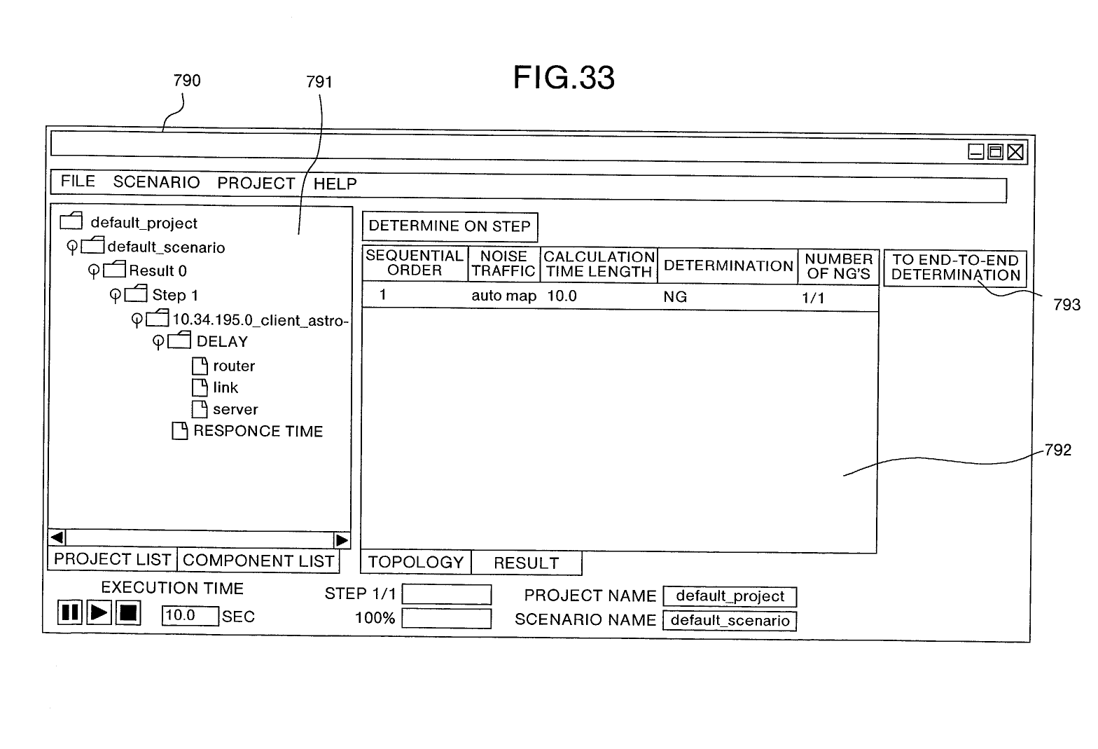

In step SP1 illustrated in FIG. 31, the result creation/management section 315 reads the step results 532₁, to 532₃ (not illustrated) illustrated in FIG. 3 from the simulation data storage section 500. In step SP2, the result creation/management section 315 marks the scenario result with “OK”. The “OK” that is so referred to here means that the scenario (in this case the future prediction scenario) satisfies the response standard. Here, the button “determine on step” illustrated in FIG. 32 is depressed, the input/output section 320 displays an image screen 790 illustrated in FIG. 33 on the screen of the display 610.

In an image screen 790, in a navigation tree display column 791, there is displayed a navigation tree 325 (see FIG. 1). In step-determination result display column 792, there are displayed the step-determination results in a table form each of that corresponds to the step result per step illustrated in FIG. 3. The step-determination result that is so referred to here is the result of determination of whether the simulated result per step satisfies the response standard (performance standard). In case the simulated result satisfies the response standard, the step-determination result is displayed as being “OK”. On the other hand, unless the simulated result satisfies the response standard, the step-determination result is displayed as “NG”.

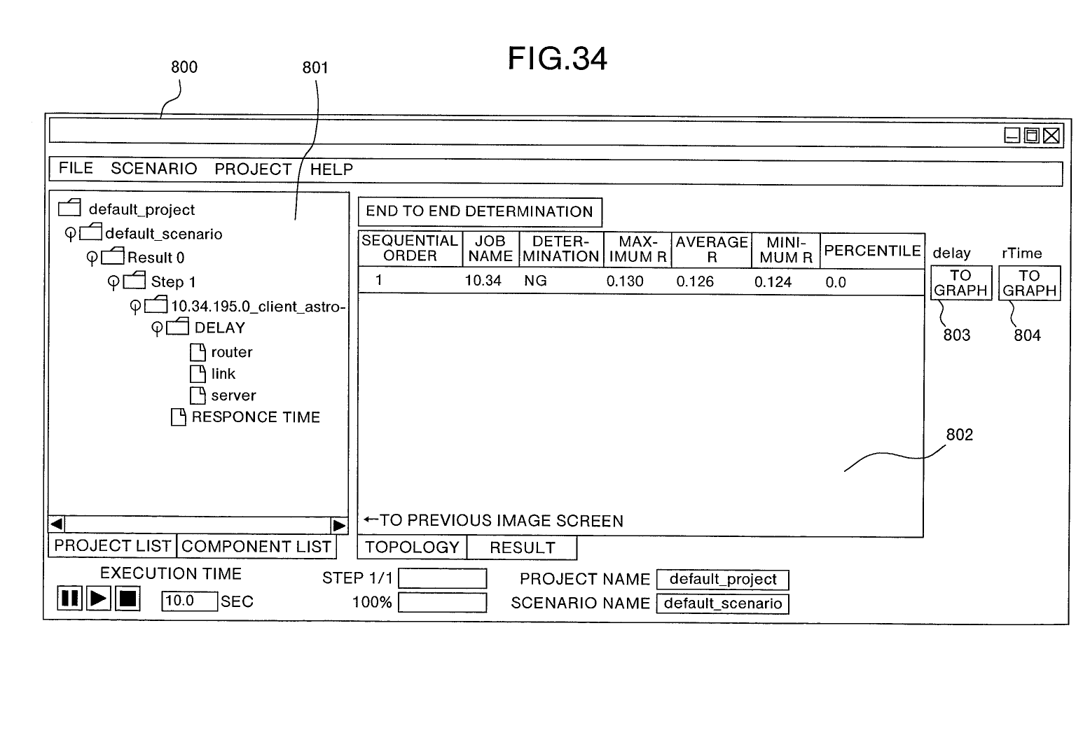

In step SP3, the result creation/management section 315 determines whether the number of steps (the remaining steps) with respect to that step determination should be done is equal to or greater than 1. The “steps” that are so referred to here mean the steps 531₁ to 531₃ (not illustrated) illustrated in FIG. 3. In this case, the result creation/management section 315 makes the determination result of the step SP3 “YES”. In step SP4, the result creation/management section 315 marks the step result (see FIG. 3) corresponding to the step with “OK”. Here, when the button “determine on End To End” illustrated in FIG. 33 is depressed, the simulation control section 313 causes an image screen 800 illustrated in FIG. 34 to be displayed on the screen of the display 610.

In this image screen 800, in a navigation tree display column 801, there is displayed a navigation tree 325 (see FIG. 1). In an End-To-End-determination result display column 802, there are displayed the End-to-End-determination results in a table form each of that corresponds to the End-to-End result illustrated in FIG. 3. The End-to-End-determination result that is so referred to here is the result of determination of whether the simulated result per End-to-End satisfies the response standard (performance standard). In case the simulated result satisfies the response standard, the End-to-End-determination result is displayed as being “OK”. On the other hand, unless the simulated result satisfies the response standard, the End-to-End-determination result is displayed as “NG”.

In step SP5, the result creation/management section 315 determines whether the number of End-to-End results, which correspond to the steps illustrated in FIG. 3 and with respect to which End-to-End determination should be done, is equal to or greater than 1. The “End-to-End determination” that is so referred to here means the determination of whether the End-to-End result satisfies the threshold value (performance standard). In this case, the result creation/management section 315 makes the determination result of the step SP5 “YES”. In step SP6, the result creation/management section 315 executes statistic calculation on the service level barometers of the End-to-End segments shown in FIG. 3.

In step SP7, the result creation/management section 315 determines whether the result of the statistic calculation is equal to or greater than the threshold value. In case the determination result is “NO”, in step SP10 the result creation/management section 315 imparts the mark “OK” to the column “determine” of the End-To-End-determination result display column 802 illustrated in FIG. 34, as the End-to-End result. On the other hand, in case the determination result of the step SP7 is “YES”, the result creation/management section 315 imparts the mark “NG” to the column “determine” of the End-To-End-determination result display column 802. In step SP9, the result creation/management section 315 imparts the mark “NG” to the column “determine” of the step result display column 792 illustrated in FIG. 33.

Thereafter, the processings on and after the step SP5 are repeatedly executed. In case the determination result of the step SP5 becomes “NO”, in step SP11 the result creation/management section 315 determines whether there are the steps the determination results of that have been made “NG”. Incase the result of this determination is “YES”, the result creation/management section 315 makes the scenario result “NG”. In this case, in the result display column 782 illustrated in FIG. 32, the letters “This scenario might not satisfy the response standard” are displayed.

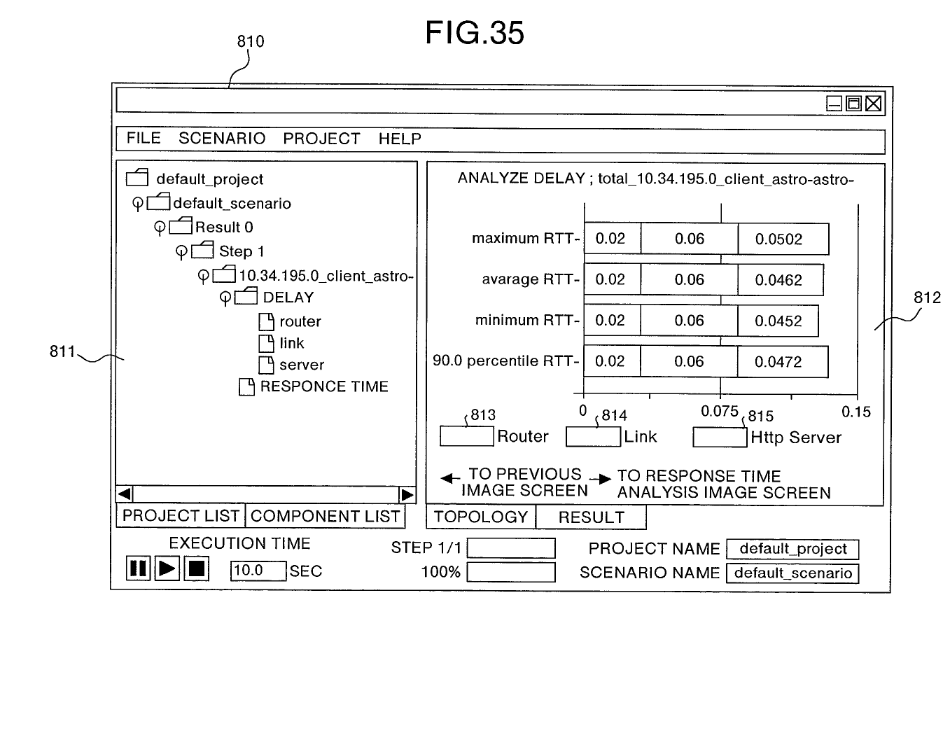

Here, when a graph display image-screen transition button 803 illustrated in FIG. 34 is depressed, the result creation/management section 315 causes an image screen 810 illustrated in FIG. 35 to be displayed on the display 610. In this image screen 810, in a navigation tree display column 811, there is displayed the navigation tree 325 (see FIG. 1). In a graph display column 812, a graph wherein the lengths of delay time that correspond to the results of the simulation are graphed is displayed. This graph is constructed of a correspondence-to-router portion 813, correspondence-to-link portion 814, and correspondence-to-HTTP server portion 815.

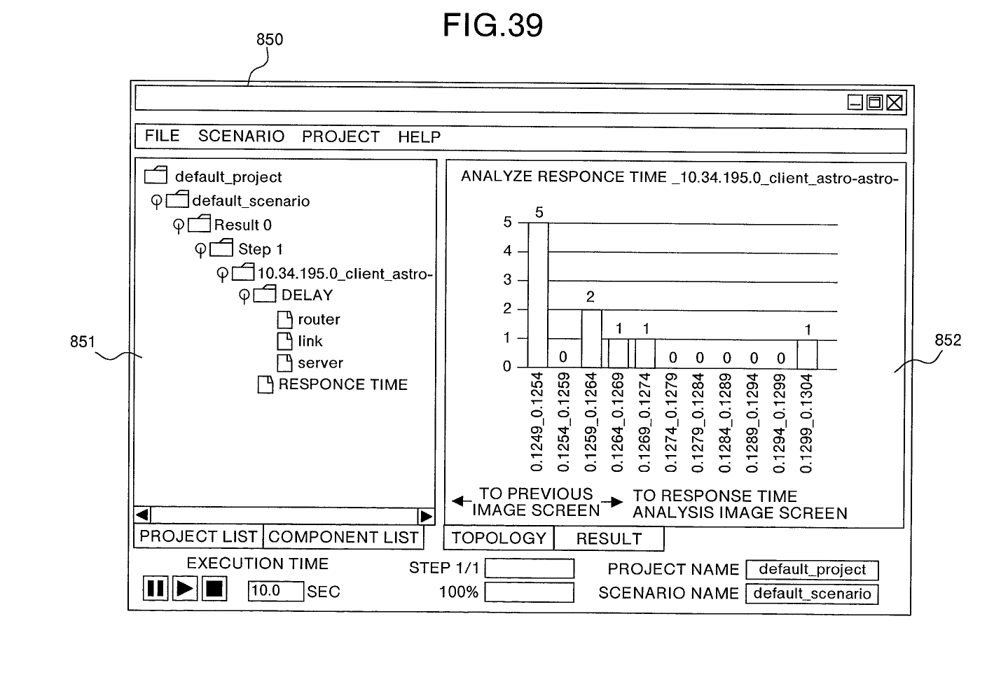

Also, when a graph display image-screen transition button 804 illustrated in FIG. 34 is depressed, the result creation/management section 315 causes an image screen 850 illustrated in FIG. 39 to be displayed on the display 610. In this image screen 850, in a navigation tree display column 851, there is displayed the navigation tree 325 (see FIG. 1). In a graph display column 852, there is displayed a graph wherein the lengths of round-trip time that correspond to the results of the simulation.

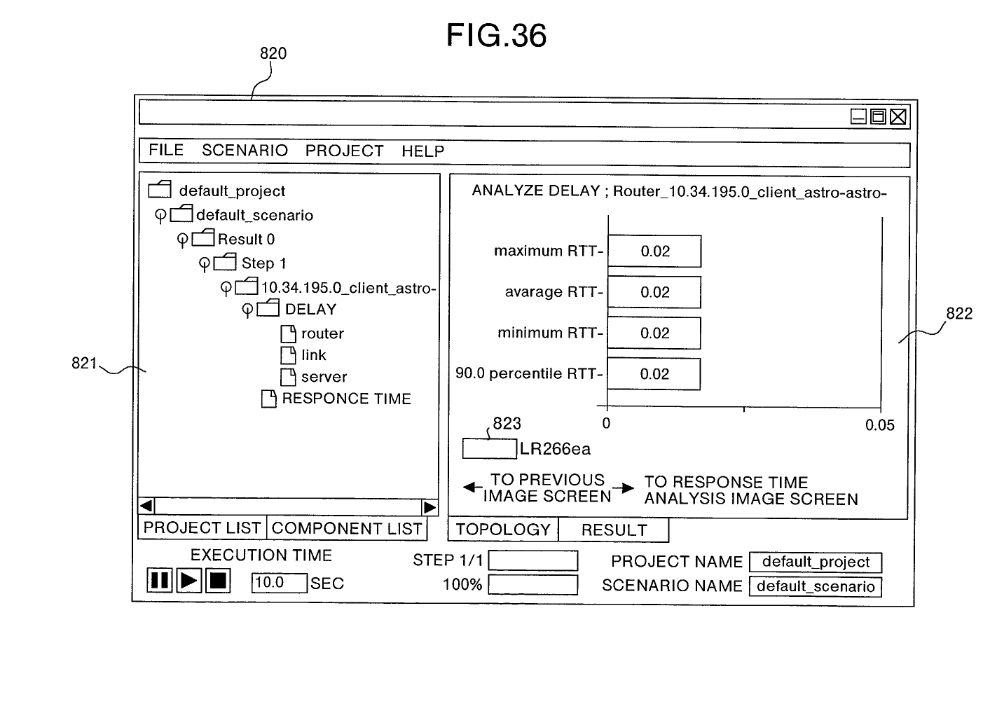

When the correspondence-to-router portion 813 of the column graph in the graph display column 812 illustrated in FIG. 35 or the “router” portion of the navigation tree display column 811 is depressed, on the display 610 an image screen 820 illustrated in FIG. 36 is displayed as the result display image screen. In this image screen 820, in a navigation tree display column 821, there is displayed the navigation tree 325 (see FIG. 1). In a graph display column 822, a graph wherein the lengths of delay time of the router corresponding to the results of the simulation are graphed is displayed.

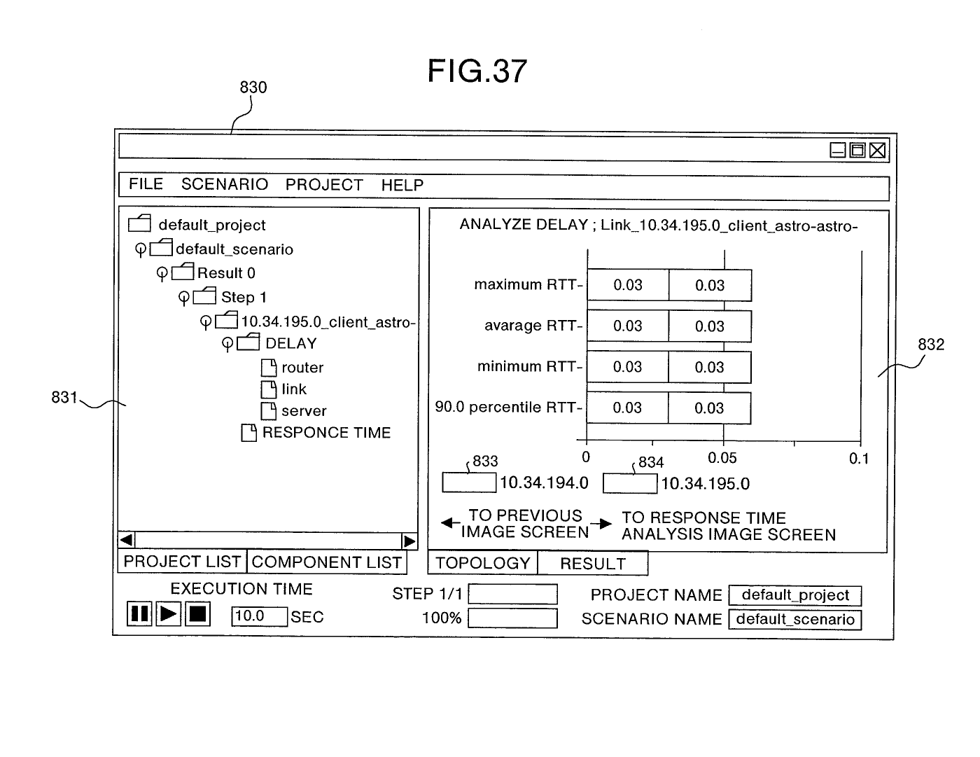

When the correspondence-to-link portion 814 of the column graph in the graph display column 812 illustrated in FIG. 35 or the “link” portion of the navigation tree display column 811 is depressed, on the display 610 an image screen 830 illustrated in FIG. 37 is displayed as the result display image screen. In this image screen 830, in a navigation tree display column 831, there is displayed the navigation tree 325 (see FIG. 1). In a graph display column 832, a graph wherein the lengths of delay time between the links corresponding to the results of the simulation are graphed is displayed. This graph is constructed of a segment portion 833 and segment portion 834 constituting the link.

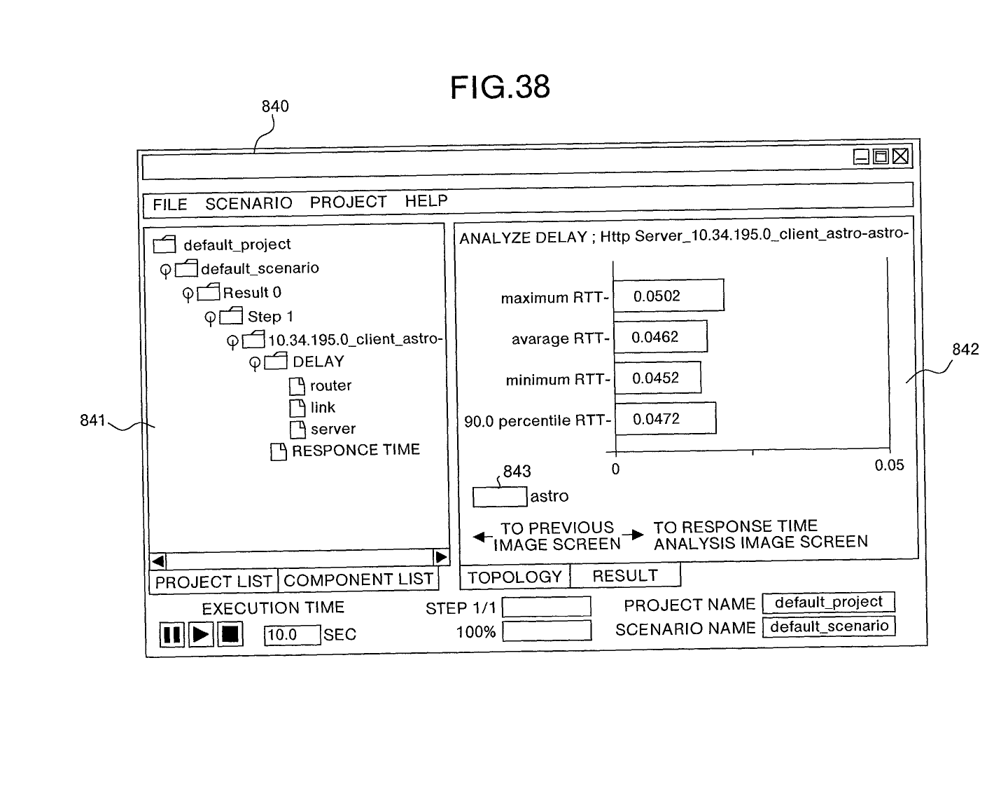

When the correspondence-to-HTTP server portion 815 of the column graph in the graph display column 812 illustrated in FIG. 35 or the “server” portion of the navigation tree display column 811 is depressed, on the display 610 an image screen 840 illustrated in FIG. 38 is displayed as the result display image screen. In this image screen 840, in a navigation tree display column 841, there is displayed the navigation tree 325 (see FIG. 1). In a graph display column 842, a graph wherein the lengths of delay time of the server corresponding to the results of the simulation are graphed is displayed. This graph is constructed of a server portion 843.

Thereafter, the processings on and after the step SP3 are repeatedly executed. Then, when the determination result of the step SP3 becomes “NO”, in step SK8 illustrated in FIG. 18 the simulation control section 310 causes the user to select whether he terminates the series of processings or repeatedly executes them. In step SK9, the simulation control section 310 determines whether the “termination” has been selected. In case the determination result is “NO”, the processings on and after the step SK5 are repeatedly executed. On the other hand, in case the determination of the step SK9 is “YES”, the simulation control section 310 releases the connection made with respect to the operation/management server 200 and causes the series of processings to have their execution terminated.

As has been described above, according to this embodiment, the operation/management server 200 and the operation/management client 300 are provided to thereby automate a series of processings of the parameter gathering, future prediction, model creation, and simulation. Therefore, it is possible to easily perform future prediction of the status quo (service level) of the network without forcedly burdening the user with a high level of knowledge or load concerned with the simulation.

Furthermore, the results of the future prediction and the results of the simulation are displayed on the display 610. Therefore, the user's interface is enhanced. Furthermore, it has been arranged to predict the possible future status over a prescribed period of time correspondingly to each of a plurality of the segment pairs. Therefore, it is possible to analyze the bottlenecks in the computer network 100. Concretely, as seen from the column graph in the graph display column 812 illustrated in FIG. 35, the portion exhibiting the greatest difference in terms of the maximum values, average values, minimum values, and 90 percentiles of the RTT (round-trip time) is the HTTP server (the correspondence-to-HTTP server portion 815). Accordingly, it is possible to predict that the possibility that the HTTP server portion will become the bottleneck is the highest.

Furthermore, it is arranged that a display be made of whether the result of the simulation satisfies the performance standard (service level) of the computer network 100 the user has preset. Therefore, in case the result of the simulation doesn't satisfy the performance standard, the user can quickly take measures with respect to this failure to satisfy.

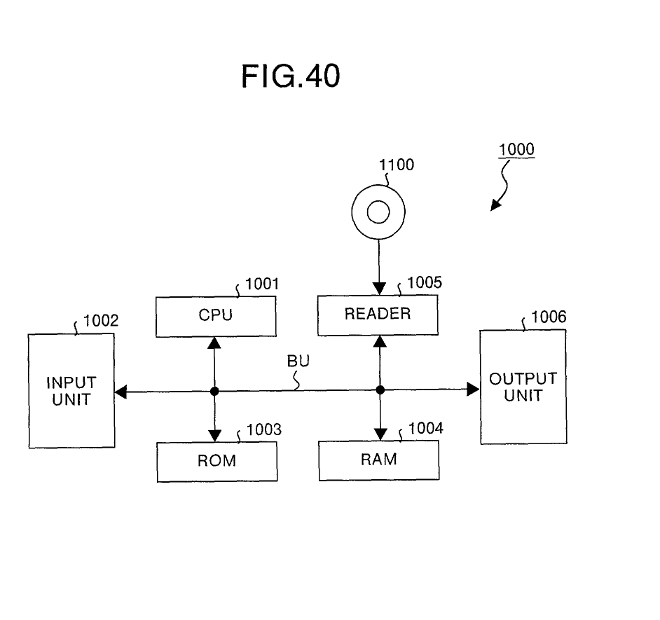

Although one embodiment of the present invention has above been described in detail with reference to the drawings, as concrete construction examples the invention is not limited to the above-described embodiment only. Even if modifications and changes are made without departing from the spirit and scope of the invention, these are included in the present invention. For instance, in the above-described embodiment, a simulation program for realizing the function of the simulator may be recorded in a computer-readable recording medium 1100 illustrated in FIG. 40. The simulation program recorded in the recording medium 1100 may be read into a computer 1000 illustrated in the same figure, whereby the simulation program is executed. It is thereby arranged to perform relevant simulation.

The computer 1000 illustrated in FIG. 40 is constructed of a CPU 1001 for executing the simulation program, an input device 1002 such as a keyboard or a mouse, a ROM (Read Only Memory) 10003 for storing therein various items of data, a RAM (Random Access Memory) 1004 for storing therein operation parameters, etc., a reading device 1005 for reading the simulation program from the recording medium 1100, an output device 1006 such as a display or a printer, and a bus BU for connecting the respective devices.

The CPU 1001 reads in the simulation program recorded in the recording medium 1100 by way of the reading device 1005 to thereby execute the simulation program to thereby perform the above-described simulation. It is to be noted that the recording medium 1100 includes not only portable recording media such as an optical disc, a floppy disk, or a hard disk but also transmission media that temporarily record and hold data as in the case of a network.

As explained above, according to the present invention, it has been arranged to automate a series of processings of the parameter gathering, future prediction, model creation, and simulation. Therefore, it is advantageously possible to easily perform future prediction of the status quo (service level) of the network without forcedly burdening the user with a high level of knowledge or load concerned with the simulation.

Furthermore, since it has been arranged to display the results of the future prediction and the results of the simulation on the display. Therefore, the user's interface advantageously is enhanced.

Furthermore, it has been arranged to predict the possible future status over a prescribed period of time correspondingly to each of a plurality of the segment pairs. Therefore, it is possible to analyze the bottlenecks in the computer network.

Furthermore, it has been arranged to display the result of the future prediction and the result of the simulation in a way that each of them corresponds to the segment pair. Therefore, the user's interface advantageously is further enhanced.

Furthermore, it has been arranged that a display be made of whether the result of the simulation satisfies the performance standard (service level) of the computer network 100 the user has preset. Therefore, in case the result of the simulation doesn't satisfy the performance standard, the user advantageously can quickly take measures with respect to this failure to satisfy.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A simulator comprising:
a parameter gathering unit that gathers parameters from a plurality of portions in a network;
a future prediction unit that according to the parameters gathered by said parameter gathering unit predicts a future state in said network over a prescribed length of time;
a model creation unit that creates a model corresponding to said network;
a parameter application unit that applies the parameters gathered by said parameter gathering unit to the model created by said model creation unit; and
a simulation unit that executes simulation according to the model created by said model creation unit.

2. The simulator according to claim 1 further comprising a display unit that displays the result of prediction by said future prediction unit and the result of simulation by said simulation unit.

3. The simulator according to claim 1,
wherein said parameter gathering unit gathers the parameters corresponding to a plurality of segment pairs in said network; and
wherein said future prediction unit predicts the future state over a prescribed length of time in corresponding relationship to a plurality of the segment pairs.

4. The simulator according to claim 3,
wherein said display unit displays the result of prediction by said future prediction unit and the result of simulation by said simulation unit in such a way that these results correspond to the segment pairs.

5. The simulator according to claim 2,
wherein said display unit displays whether the result of simulation by said simulation unit satisfies the performance standard of said network that has been set by a user beforehand.

6. A simulation method comprising the steps of:
gathering parameters from a plurality of portions in a network;
predicting a future state in said network over a prescribed length of time based on the gathered parameters;
creating a model corresponding to said network;
applying the gathered parameters to the created model; and
executing simulation based on the created model.

7. The simulation method according to claim 6, further comprising a step of displaying the result of prediction and the result of simulation.

8. The simulation method according to claim 6,
wherein parameters are gathered corresponding to a plurality of segment pairs in said network; and
the future state is predicted over a prescribed length of time in corresponding relationship to a plurality of the segment pairs.

9. The simulation method according to claim 7,
wherein the result of prediction and the result of simulation are displayed in such a way that these results correspond to the segment pairs.

10. A computer readable medium for storing instructions, which when executed on a computer, causes the computer to perform the steps of:
gathering parameters from a plurality of portions in a network;
predicting a future state in said network over a prescribed length of time based on the gathered parameters;
creating a model corresponding to said network;
applying the gathered parameters to the created model; and
executing simulation based on the created model.
